(19) United States
(12) Patent Application Publication
(10) Pub. No.: US 2015/0077234 A1
(43) Pub. Date: Mar. 19, 2015

(54) SYSTEM OF WEARABLE DEVICES WITH SENSORS FOR SYNCHRONIZATION OF BODY MOTIONS BASED ON HAPTIC PROMPTS

(71) Applicant: Scott Fullam, Palo Alto, CA (US)

(72) Inventor: Scott Fullam, Palo Alto, CA (US)

(73) Assignee: AliphCom, San Francisco, CA (US)

(21) Appl. No.: 14/029,300

(22) Filed: Sep. 17, 2013

(51) Int. Cl. G08B 6/00

(52) U.S. Cl. CPC G08B 6/00
USPC 340/407.1

(57) ABSTRACT

Embodiments of the present application relate generally to personal electronics, portable electronics, wearable electronics, and more specifically to wirelessly enabled devices that include a haptic interface and are configured to wirelessly communicate with one another to synchronize body motion or other user actions based on haptic prompts generated by a sensor system in one or more of the wirelessly enabled devices. Each wirelessly enabled device may include at least one radio configured to transmit, receive or both, RF signals encoded with motion data operative to generate sensory outputs from the haptic interface of one or more of the wirelessly enabled devices. At least one of the wirelessly enabled devices may be configured as a leader device and one or more other wirelessly enabled devices may be configured as a follower device. One or more wirelessly enabled devices may be wirelessly linked to a wireless media device that generates motion data.

### CROSS-REFERENCE TO RELATED APPLICATIONS

This application is related to the following applications: U.S. patent application Ser. No. 13/181,512, filed on Jul. 12, 2011, having Attorney Docket No. ALI-003, and titled “Media Device, Application, And Content Management Using Sensory Input”; and U.S. patent application Ser. No. 13/898,451, filed on May 20, 2013, having Attorney Docket No. ALI-003CIP1, and titled “Media Device, Application, And Content Management Using Sensory Input Determined By A Data-Capable Watch Band”, all of which are hereby incorporated by reference in their entirety for all purposes.

### FIELD

These present application relates generally to personal electronics, portable electronics, wearable electronics, and more specifically to wirelessly enabled devices that include a haptic interface and are configured to wirelessly communicate with one another to synchronize body motion or other user action based on haptic prompts generated by a sensor system in one or more of the wirelessly enabled devices.

### BACKGROUND

In some circumstances it may be desirable for a group of people to synchronize, coordinate, or otherwise order their respective motions, actions, or conduct relative to one another. Examples may include activities such as dancing, athletic endeavors, sports, recreation, meetings, social gatherings, and exercise, just to name a few. However, in some examples, using voice prompts, physical prompts, sound prompts, visual prompts, etc., may not be effective, especially if some of the participants cannot sensually perceive the person/apparatus giving the prompts. In a large group of people, it may not be possible for every participant to sense the prompts in a manner that makes it easy for all participants to effectively sense the prompts at the same time or substantially at the same time. Therefore, participants who are not able to sensually perceive (e.g., within ear shot or line of sight) the person or apparatus giving the prompts may not be able to react to those prompts in an appropriate manner, compared to participants who are able to sensually perceive the prompts.

Accordingly, there is a need for wireless devices that may be worn or otherwise mechanically coupled with a plurality of users and configured to transmit and/or receive motion signals or other signals that are processed by a haptic interface to synchronize body motion or other user action based on haptic prompts generated by a sensor system in one or more of the wireless devices.

### BRIEF DESCRIPTION OF THE DRAWINGS

Various embodiments or examples (“examples”) of the present application are disclosed in the following detailed description and the accompanying drawings. The drawings are not necessarily to scale:

FIG. 1A depicts a block diagram of one example of a wearable wireless device, according to an embodiment of the present application;

FIG. 1B depicts a side profile view of one example of a housing for a wearable wireless device, according to an embodiment of the present application;

FIG. 1C depicts a cross-sectional view of one example arrangement of components for a wearable wireless device, according to an embodiment of the present application;

FIG. 1D depicts a profile view of one example arrangement of components for a wearable wireless device, according to an embodiment of the present application;

FIG. 2 depicts an exemplary computer system according to an embodiment of the present application;

FIGS. 3A-3H depict views of different example configurations of a wearable wireless device, according to an embodiment of the present application;

FIG. 4A depicts examples of users wearing leader and follower wearable wireless devices, according to an embodiment of the present application;

FIGS. 4B-4D depict additional examples of users wearing leader and follower wearable wireless devices, according to an embodiment of the present application;

FIG. 5A depicts one example of a wireless media device and follower devices wirelessly linked with the wireless media device, according to an embodiment of the present application;

FIG. 5B depicts one example of a wireless media device wirelessly linked with leader and/or follower devices, according to an embodiment of the present application;

FIG. 6 depicts several examples of how devices may be wirelessly linked with one another, according to an embodiment of the present application;

FIG. 7 depicts several examples of how devices may be wirelessly linked with external devices, according to an embodiment of the present application;

FIG. 8 depicts one example of a remote session and optional advancing or retarding haptic prompts, according to an embodiment of the present application;

FIG. 9 one example of a communication port, according to an embodiment of the present application; and

FIG. 10 depicts one example of a flow diagram for a wearable wireless device, according to an embodiment of the present application.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying drawing FIGS. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

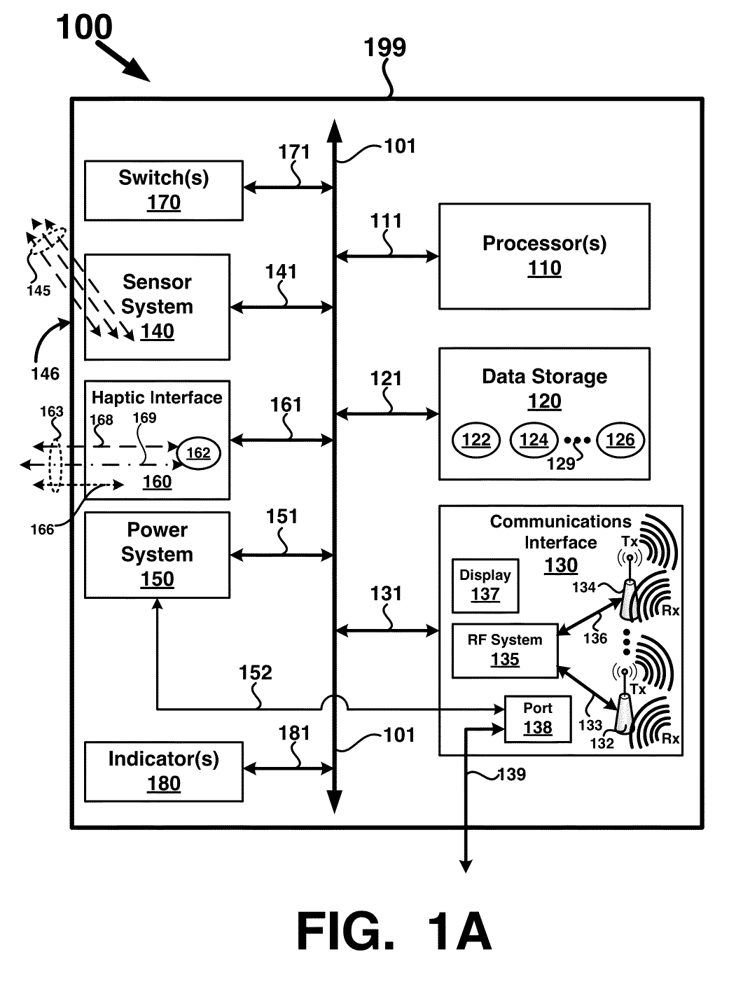

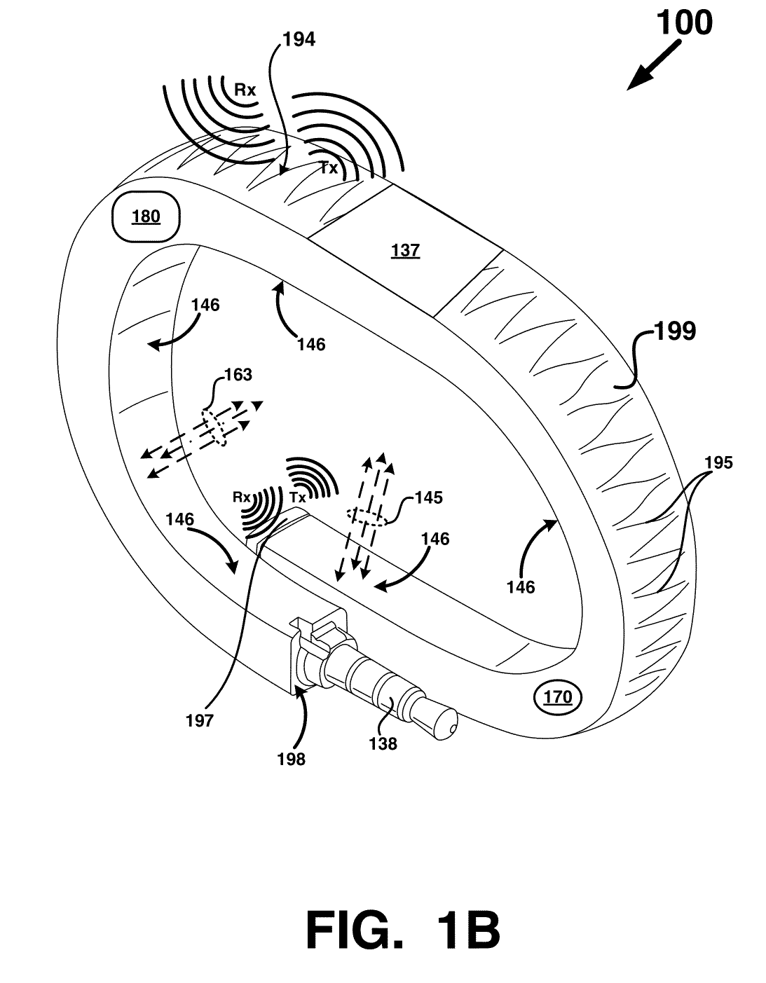

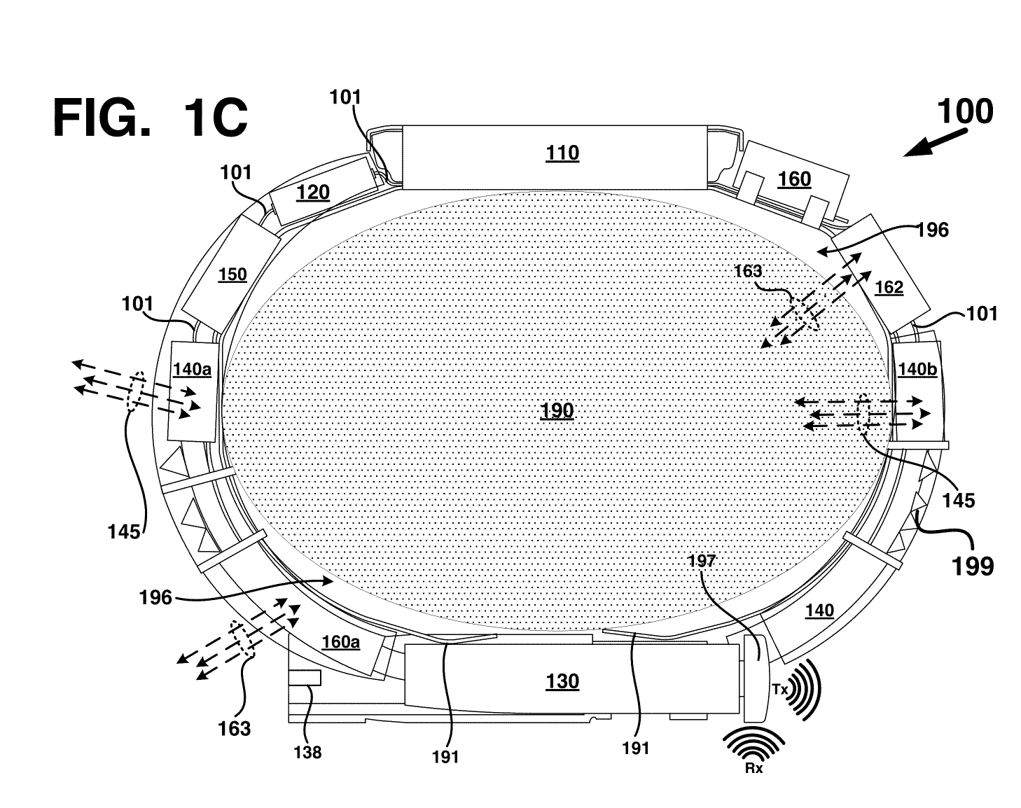

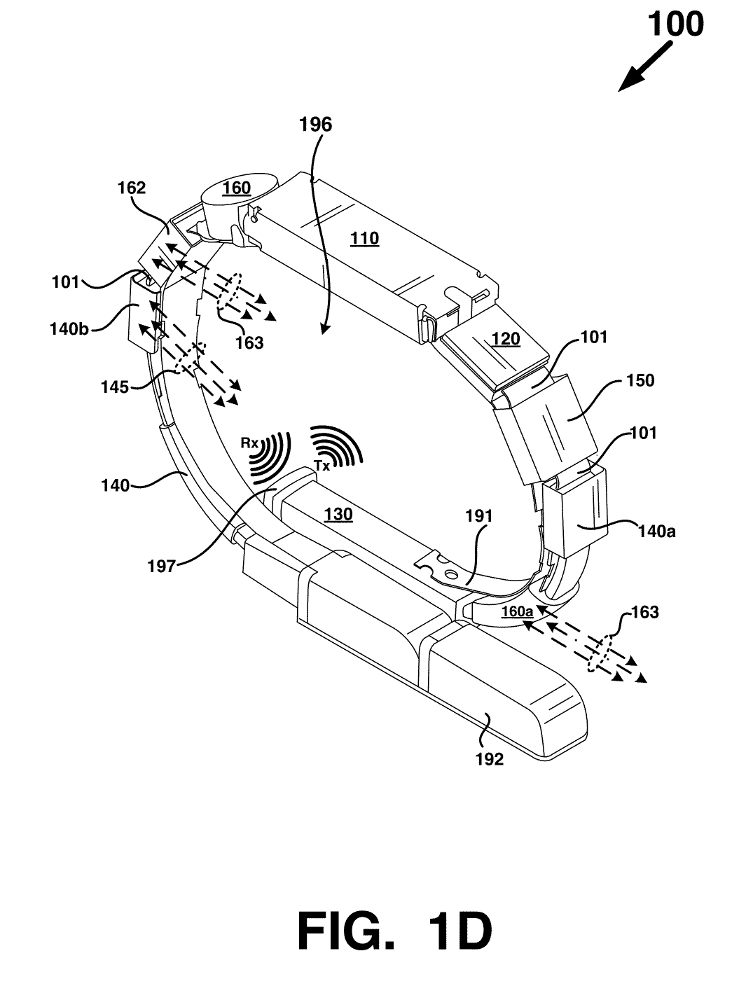

FIG. 1A depicts a block diagram of one example of a wearable wireless device 100 (device 100 hereinafter). Device 100 may include one or more processors 110 (e.g., μP, μC, DSP, ASIC, FPGA), data storage 120 (e.g., Flash, RAM, ROM, volatile memory, non-volatile memory), a communications interface 130, a sensor system 140, a power system 150, a haptic interface 160, one or more switches 170, and one or more indicators 180. In some applications, some of the elements of device 100 may be optional and device 100 may not include all of the elements depicted in FIG. 1A. For example, device 100 may not include indicators 180 and/or switches 170. Components of device 100 may be electrically coupled (111, 121, 131, 141, 151, 161, 171, 181) with a bus 101 and may electrically communicate with one another using bus 101 or other system of electrical interconnect. One or more of processor(s) 110, power system 150, or communications interface 130 (e.g., RF system 135) may be selected based on low power consumption criteria. Moreover, the RF system 135 may be configured to transmit at a low RF power so that an external wireless device may only reliably wirelessly communicate with device 100 (e.g., near field proximity) when it is in close proximity to device 100 as will be described below. Transmitting information at the a low RF power may insure privacy of information or wireless linking or paring between devices 100 that may otherwise be compromised or intercepted if the device 100 transmitted at higher power levels associated with non-near field wireless communications that may be received by any number of wireless devices within a large distance from the device 100 (e.g., >1 meter).

Indicator 180 may be a LED, LCD, or other type of display or indicator light that shows status of device 100. For example, indicator 180 may be a LED that flashes, blinks or otherwise provides a visual signal that the device 100 is performing some function, such as wirelessly communicating (e.g., Tx) information in response to some motion event as will be described below. Indicator 180 may be deactivated by activating switch 170 (e.g., pressing a button or the like) or after a predetermined time has elapsed. Switch 170 may be used to activate several functions including but not limited to activating the device 100 to transmit information, deactivate the device 100 to terminate transmission of information, cycle power for device 100 on or off, indicate status of power system 150 (e.g., battery life remaining), and indicate status of device 100, just to name a few.

Device 100 may be positioned and/or disposed on a housing 199. Housing 199 may be configured to be worn at a variety of locations on a body of users that wear the device 100. Example locations include but are not limited to: wrist; arm, leg, neck, head, forehead; ear, torso, chest, thigh, calf, ankle, knee, elbow, biceps, triceps, abdomen; back, waist, and stomach, just to name a few. Switch 170 and/or indicator 180 may be positioned on the housing 199. In other examples, housing 199 and components of device 100 may be integral with, fabricated in, or otherwise integrated with an article of clothing worn by a user, such as a shirt, pants, shorts, socks, jacket, tights, hat, armband, wrist band, headband, just to name a few. In some examples, the user may not be a human being and may comprise some other life form such as an animal, pet, livestock, equine, mammal, sea creature, denizen of the deep, insect, avian, or other. Housing 199 may be configured to be worn, implanted, or otherwise mounted or connected with the life form.

Sensor system 140 may contain one or more sensors and those sensors may be configured to sense different types of data including but not limited to motion, acceleration, deceleration, vibration, rotation, translation, temperature, activity, sleep, rest, and physiological data, just to name a few. For example, sensor system 140 may include at least one motion sensor configured to generate at least one motion signal (e.g., on 141) in response to motion of a body of a user (e.g., a leader as will be described below). Optionally, sensor system 140 may include at least one physiological sensor configured to generate at least one physiological signal in response to physiological activity in the body of the user. Sensor system 140 may sense 145 events that occur external to housing 199 of device 100. Sensor system 140 may sense 145 events caused by contact 146 between housing 199 and/or sensor(s) with a portion of the user's body. For example, sensor electrodes positioned on housing 199 may measure skin conductivity (SC) of a portion of user's skin that comes into contact with the sensor electrodes. As another example, a thermally conductive sensor structure (e.g., temperature probe) on housing 199 may thermally conduct heat from a portion of the user's body or an ambient in which the user is present to measure temperature (e.g., body temperature, ambient temperature or both).

Haptic interface 160 may include one or more transducers and/or sensors including but not limited to a speaker, a vibration engine, a vibration motor, a piezoelectric device, a tactile sensor, a tactile feedback engine, or any component configured to impart force, vibration, motion, touch related sensory cue, or mechanical stimulation to a body of the user, just to name a few. For example, a speaker may be used to provide audible alerts, alarms, generate voice messages, or generate vibrations (e.g., sensory cues), just to name a few. A vibration engine and/or vibration motor may be used to generate vibrations for a variety of purposes including but not limited to haptic feedback, alerts, stimulate the user, mimic motion or vibration included in a motion signal from another device 100, just to name a few. Processor 110 in a device 100 may receive 141 motion signals from sensor system 140 or wirelessly receive motion signals from another device 100 (e.g., motion signals generated by the sensory system 140 of the another device 100) and process the motion signal to generate a haptic signal that is electrically coupled 161 with haptic interface 160 and operative to command the haptic interface 160 to generate haptic feedback 166 to the user wearing device 100. One or more algorithms and/or data stored in data storage 120 may be used (e.g., executed) by processor 110 to process the motion signals and generate the haptic signal.

In some examples, haptic interface 160 may include a tactile system 162 responsive to a tactile event 168 such as an external force, pressure, vibration, touch, or other form of mechanical coupling, such as a finger or hand of a user applying touch, pressure or force to the tactile system, for example. As one example, a button, switch (e.g., switch(s) 170), or display (e.g., display 137) of device 100 may generate tactile feedback 169 when actuated by a user and/or generate a tactile signal (e.g., on 161) from haptic interface 160. Successful actuation 168 of the tactile system 162 may generate tactile feedback 169 (e.g., a vibration or the like) that is felt or otherwise perceived by the user or other system external to device 100. Therefore, tactile system 162 may receive a tactile event 168 from an external source, may generate tactile feedback 169 that is perceived externally, or both. In some examples the tactile feedback 169 may be generated by a vibration engine, vibration motor, or other force/vibration/motion generating device. In other examples, tactile feedback 169 may comprise, complement, or supplement the haptic feedback 166. One or more of the haptic feedback 166, the tactile feedback 169 and the tactile event 168 may be referred to as a haptic event 163.

Power system 150 may include a rechargeable power source such as a rechargeable battery (e.g., Lithium Ion, Nickel Metal Hydride, or the like). Power system 150 may provide the same or different power supplies (e.g., different supply voltages) for the various blocks in device 100. Power system 150 may be electrically coupled 152 to an external source of power via port 138 (e.g., a USB connector, TRS or TRRS connector, or other type of electrical connector. The external source of power may be used to power device 100 and/or recharge the rechargeable power source. Connection 139 may be electrically coupled with the external source of power and/or an external device, and electrical power, data communication or both may be carried by connector 139.

Data storage 120 may include a non-transitory computer readable medium (e.g., Flash memory) for storing data and algorithms used by processor 110 and other components of device 100. Data storage may include a plurality of different types of data and algorithms 122-126. There may be more or fewer types of data and algorithms as denoted by 129. Data storage 120 may include other forms of data such as an operating system (OS), boot code, BIOS, firmware, encryption code, decryption code, applications (APP), wireless communication protocols (e.g., Bluetooth, NFC, WiFi, Ad Hoc WiFi, HackRF, USB-powered software-defined radio (SDR), etc.), for use by processor 110 or other components of device 100. Data storage 120 may include storage space used by processor 110 and/or other components of device 100 for general data storage space, scratch pads, hash tables, look-up tables, buffers, cache memory, registers, or the like. Data storage 120 may include volatile memory, non-volatile memory or both.

Communications interface 130 includes a RF system 135 having one or more radios 132 and 134 operative as a wireless communications link between the device 100, one or more other devices 100, and optionally one or more external wirelessly enabled devices (e.g., a smartphone, a tablet, wireless media device, or pad). Although two radios (132, 134) are depicted, RF system 135 may include more radios or fewer radios. RF system 135 may be configured to transmit only Tx, receive Rx only, or both transmit Tx and receive Rx, depending on a configuration of each device 100. For example, one or more devices 100 may be configured as leader devices (e.g., master device) that transmit motion signals; whereas, one or more other devices 100 may be configured as follower devices 100 (e.g., slave devices) that receive transmitted motion signals and generate haptic feedback 166 based on the received motion signals. Device 100 may be configured to serve as either a leader or follower device having both transmit Tx and receive Rx capability in one or more of the radios in RF system 135.

In some applications one or more users may wear or otherwise be mechanically coupled with a plurality of the devices 100. For example, one user may be the leader and may wear four of the devices 100 configured as leader devices, with one leader device on each wrist and each ankle, and one or more other users may be followers and may wear four of the devices 100 configured as follower devices, with one follower device on each wrist and each ankle. In that leader devices are configured to wirelessly transmit motion signals, each leader device 100 includes a radio that transmits Tx RF signals, but may also have a radio configured to receive Rx RF signals. Similarly, follower devices 100 at lease include a radio configured to receive Rx RF signals transmitted by the leader device(s) 100, but may also have a radio configured to transmit Tx RF signals. When there is a plurality of leader and follower devices, specific leader and follower devices may be configured to wirelessly link with one another so that motions signals transmitted from the specific leader device(s) are only received and acted on by the specific follower device(s), as will be explained in greater detail below. For example if a leader user has a leader device 100 on each of her left and right wrists and on each of her left and right ankles, then the right wrist leader device 100 wirelessly links with the right wrist follower devices 100 on all follower users, the right ankle leader device 100 wirelessly links with the right ankle follower devices 100 on all follower users, and so forth for the left wrist and left ankle follower and leader devices 100.

In some examples, the leader device 100 may include different components than the exampled depicted in FIG. 1A. As one example, a leader device 100 may be configured to only transmit Tx motion signals to one or more follower devices 100 and may therefore not include the haptic interface 160. Leader device 100 may include a RF system 135 having transmit Tx only capability and may be configured to pair, sync, or otherwise establish a communications link with one or more follower devices 100 using an electrical connection 139 between port 138 on the leader device 100 and ports 138 on the one or more follower devices 100.

Port 138 may be used to electrically couple 139 the communications interface 130 with an external device and/or external communications network. Port 138 may also be used to supply electrical power to power system 150. Communications interface 130 may also include a display 137 operative to communicate information to a user. Display 137 may be a LCD, OLED, LED, or touch screen type of display, for example. Display 137 may be a passive display that does not accept user interaction, or display 137 may be an active display configured to accept user interaction (e.g., a touch screen display). In some applications display 137 and indicators 180 may replace or supplement each other.

Reference is now made to FIG. 1B where a side profile view of one example of a housing 199 for a wearable wireless device 100 is depicted. Housing 199 may include ornamentation or esthetic structures denoted as 195. Structures 195 may also serve a functional purpose such as providing traction or a gripping surface for a user. Portions of housing 199 may include contact points 146 between the housing 199 and portions of a body of a user (not shown). Sensors from sensor system 140 may be positioned proximate the contact points 146 to sense 145 motion and/or physiological activity in the users body. For example, a physiological sensor configured to measure heart rate of a user may be positioned at a specific contact point 146 where a user's pulse may detected (e.g., proximate an artery on the wrist). A structure 197 (e.g., an electrically conductive material) may be operative as the antenna 134. Alternatively, some other location 194 in housing 199 may be used to house the antenna 134. Furthermore, the antenna 134 may be concealed by the housing 199. A portion 198 of housing 199 may include port 138 (e.g., a TRS plug, TRRS plug, USB connector, or some other connector type). Housing 199 may be configured to be wrapped around a portion of a user's body and to retain its shape after it is wrapped around the portion. Housing 199 may include the display 137 positioned at an appropriate location on the housing 199. Additionally, housing 199 may include one or more indicators and/or switches (180, 170). Actual locations of the display 137, the indicator 180, and the switches 170 and actual shape, size, features, and configuration of the housing 199 will be application dependent and are not limited to the examples depicted herein.

Moving on to FIGS. 1C and 1D, a cross-sectional view and profile view, respectively, depict of one example arrangement of components within the hosing 199 of device 100. Housing 199 is depicted enclosing (e.g., wrapped around) a portion 190 of a body of a user (e.g., an ankle, leg, arm, wrist, neck, head, etc.). Some or all of portion 190 may contact housing 199 along its interior surfaces denoted as 196. The positions of the components in FIG. 1C is non-limiting and provided only for purposes of explanation. Actual shapes for housing 199 and position of components (110, 120, 130, 140, 150, 160, 170, 180) within housing 199 will be application dependent and are not limited to the examples depicted and/or described herein.

The components (110, 120, 130, 140, 150, 160, 170, 180) may be electrically coupled with one another via bus 101. Bus 101 may be one or more electrically conductive structures, such as electrical traces on a PC board, flexible PC board, or other substrate, for example. At least some of the components (110, 120, 130, 140, 150, 160, 170, 180) may be positioned at more than one location within housing 199, such as sensor system 140, power system 150, RF system 135, antenna(s) (132, 134), and haptic interface 160, for example. Sensor system 140 may be positioned in housing 199 to sense 145 activity (e.g., physiological activity) from the user body (e.g., via portion 190) as denoted by sensor 140b; whereas, other sensor positions may be configured to sense 145 other types of activity or parameter (e.g., motion or temperature) as denoted by 140a and those activities and/or parameters may be external to the users body (e.g., ambient temperature or sound). Although one location is depicted, power system 150 may be positioned at multiple locations within housing 199. Haptic interface 160 may be positioned so that it is close to tactile system 162, for example. Further haptic system 160 may be disposed in multiple locations in housing 199, such as 160a, for example. RF system 130 may be positioned close to antenna 197 and away from other components that may be sensitive to RF signals. Processor 110 and data storage 120 may be positioned in close proximity of each other to reduce latency for memory operations to/from processor 110 and data storage 120. In FIG. 1D, a removable cover 192 may be configured to cap the data port 138 and may server to protect the data port 138 from moisture, contamination, and electrostatic discharge (ESD), for example. A removable cover 192 may also serve an esthetic purpose. One or more structures 191 may serve to retain a shape of the housing 199 after it has been wrapped or otherwise positioned on the body portion 190.

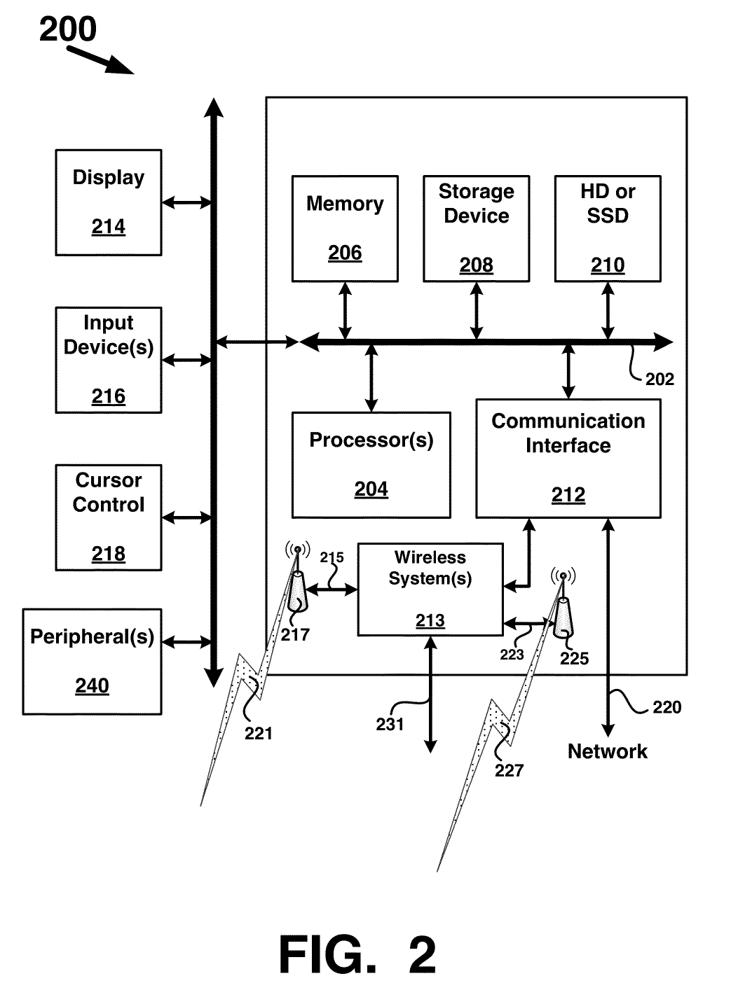

FIG. 2 depicts an exemplary computer system 200 suitable for use in the systems, methods, and apparatus described herein. In some examples, computer system 200 may be used to implement circuitry, computer programs, applications (e.g., APP's), configurations (e.g., CFG's), methods, processes, or other hardware and/or software to perform the above-described techniques. Computer system 200 includes a bus 202 or other communication mechanism for communicating information, which interconnects subsystems and devices, such as one or more processors 204, system memory 206 (e.g., RAM, SRAM, DRAM, Flash), storage device 208 (e.g., Flash, ROM), disk drive 210 (e.g., magnetic, optical, solid state), communication interface 212 (e.g., modem, Ethernet, WiFi, Bluetooth, Ad Hoc WiFi, HackRF, USB-powered software-defined radio (SDR), etc.), display 214 (e.g., CRT, LCD, touch screen), one or more input devices 216 (e.g., keyboard, stylus, touch screen display), cursor control 218 (e.g., mouse, trackball, stylus), one or more peripherals 240. Some of the elements depicted in computer system 200 may be optional, such as elements 214-218 and 240, for example and computer system 200 need not include all of the elements depicted.

According to some examples, computer system 200 performs specific operations by processor 204 executing one or more sequences of one or more instructions stored in system memory 206. Such instructions may be read into system memory 206 from another non-transitory computer readable medium, such as storage device 208 or disk drive 210 (e.g., a HD or SSD). In some examples, circuitry may be used in place of or in combination with software instructions for implementation. The term “non-transitory computer readable medium” refers to any tangible medium that participates in providing instructions to processor 204 for execution. Such a medium may take many forms, including but not limited to, non-volatile media and volatile media. Non-volatile media includes, for example, optical, magnetic, or solid state disks, such as disk drive 210. Volatile media includes dynamic memory, such as system memory 206. Common forms of non-transitory computer readable media includes, for example, floppy disk, flexible disk, hard disk, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 202 for transmitting a computer data signal. In some examples, execution of the sequences of instructions may be performed by a single computer system 200. According to some examples, two or more computer systems 200 coupled by communication link 220 (e.g., NFC, LAN, Ethernet, PSTN, wireless network, Bluetooth (BT), or other) may perform the sequence of instructions in coordination with one another. Computer system 200 may transmit and receive messages, data, and instructions, including programs, (i.e., application code), through communication link 220 and communication interface 212. Received program code may be executed by processor 204 as it is received, and/or stored in a drive unit 210 (e.g., a SSD or HD) or other non-volatile storage for later execution. Computer system 200 may optionally include one or more wireless systems 213 in communication with the communication interface 212 and coupled (215, 223) with one or more antennas (217, 225) for receiving and/or transmitting RF signals (221, 227), such as from a WiFi network, Ad Hoc WiFi, HackRF, USB-powered software-defined radio (SDR), BT radio, device 100, or other wireless network and/or wireless devices, for example. Examples of wireless devices include but are not limited to: a data capable strap band, wristband, wristwatch, digital watch, or wireless activity monitoring and reporting device; a smartphone; cellular phone; tablet; tablet computer; pad device (e.g., an iPad); touch screen device; touch screen computer; laptop computer; personal computer; server; personal digital assistant (PDA); portable gaming device; a mobile electronic device; and a wireless media device, just to name a few. Computer system 200 in part or whole may be used to implement one or more systems, devices, or methods that communicate with device 100 via RF signals (e.g., RF System 135) or a hard wired connection (e.g., data port 138). For example, a radio (e.g., a RF receiver) in wireless system(s) 213 may receive transmitted RF signals (e.g., Tx) from device 100 that include one or more motion signals, haptic signals, or other data. Computer system 200 in part or whole may be used to implement a remote server or other compute engine in communication with systems, devices, media devices, or method for use with the device 100 as described herein. Computer system 200 in part or whole may be included in a portable device such as a smartphone, tablet, gaming device, or pad.

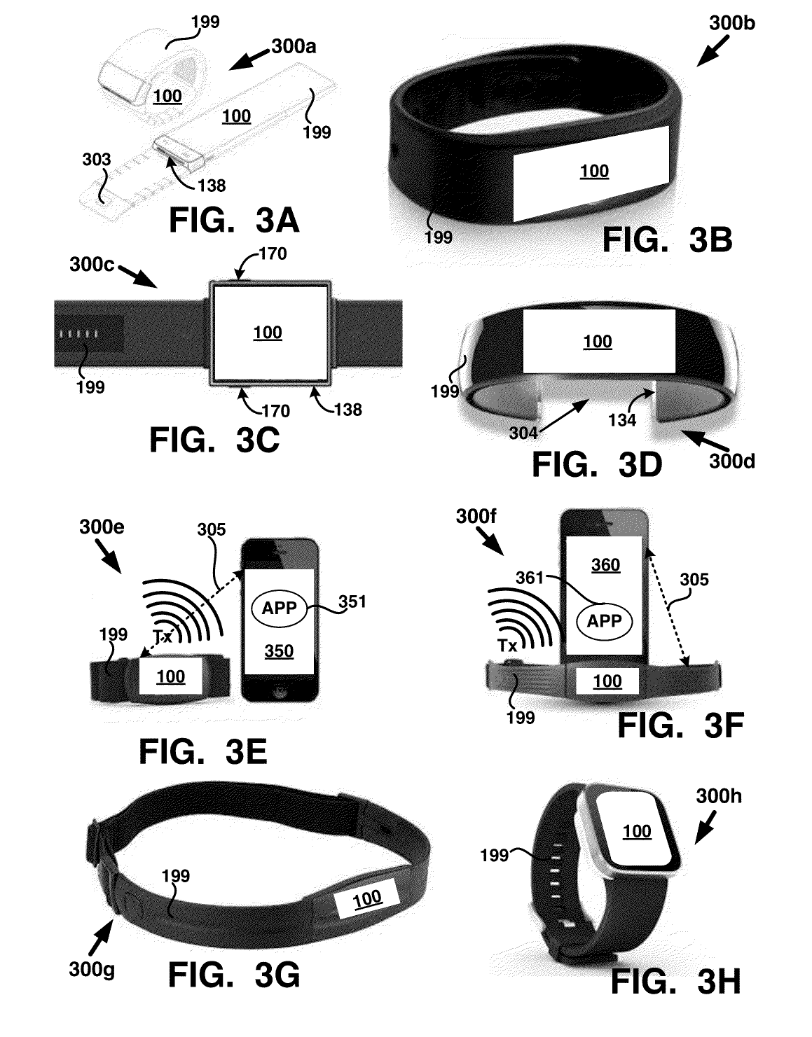

FIGS. 3A-3H depict views of different example configurations for device 100. The configurations depicted are non-limiting examples of shapes, designs and features that may be included in device 100 and its housing 199. In FIG. 3A configuration 300a depicts a housing 199 configured as a band show in a folded or wrapped position and in un-folded position. In the un-folded position a clasp 303 or the like may be used to secure the device 100 to the body of the user (e.g., portion 190). A portion of the housing 199 may include an opening to provide access to data port 138. The device 100 may be configured to be worn about the wrist, arm, leg, or other position on the body of the user. Configuration 300a may not include the display 137; whereas, in some application the device 100 may include the display 137.

FIGS. 3B-3D and 3H depict other example configurations 300b-300d and 300h for devices 100 having housings 199 that may be worn like a band or wristwatch on the body of the user. In FIG. 3C, configuration 300c may include a housing 199 having a shape similar to that of a wristband or wristwatch. Housing 199 may include a portion for positioning one or more switches 170 that may be actuated by the user to activate one or more functions (e.g., activating display 137) of device 100. In FIG. 3C a portion of the housing 199 may include an opening to provide access to data port 138. In FIG. 3D, configuration 300d for housing 199 may include a portion (e.g., an electrically conductive structure) for antenna 134. In FIGS. 3B and 3D, configurations 300b and 300d may have housings 199 having a shape similar to that of a band, with configuration 300b having a band configured to wrap around a portion of the user's body (e.g., portion 190), and configuration 300d having an opening configured to allow the band to be slipped over a portion of the user's body (e.g., the wrist or arm). In FIGS. 3B-3D and 3H, the housing may include the display 137 in that the configurations 300b, c, d and h may allow for easy viewing of the display 137 by the user at the body position the housing 199 is affixed to. In FIG. 3G, configuration 300g may comprise a housing 199 adapted to fit on a larger section of the users body, such as the chest, torso, head, thigh, or waist, for example. Configuration 300g may not include the display 137 positioned on the housing 199 in that it may be difficult for the user to view the display 137 at the body position the housing 199 is affixed to (e.g., around the chest).

FIGS. 3E-3F depict configurations 300e and 300f where the device 100 is configured to transmit one or more datum (e.g., motion signals) at a low RF power level that may be received by an external wireless device (350, 360) that is in close proximity (e.g., near field proximity) of the device 100. For example, the low RF power may have an effective short range wireless distance 305 of approximately 30 cm or less. Distance 305 may be relative to some position on housing 199, such as a portion of the housing 199 where the antenna 134 is located, for example (e.g., 197 of FIGS. 1B-1D). Distance 305 may be 0 (e.g., direct contact between device 100 and external wireless devices 350 or 360) or some distance such as 100 cm or less between the device 100 and device 350 or 360, for example. Configurations 300e and 300f depict different shapes for housing 199, with configuration 300e adapted to fit on a smaller portion of a user's body (e.g., arm, wrist, or ankle) than configuration 300f which is adapted to fit a larger portion (e.g., chest, torso, or thigh). External wireless devices 350 and 360 may include but are not limited to smartphones, pads, tablets, laptops, PC, gaming device, PDA, a smart watch, a media device, just to name a few.

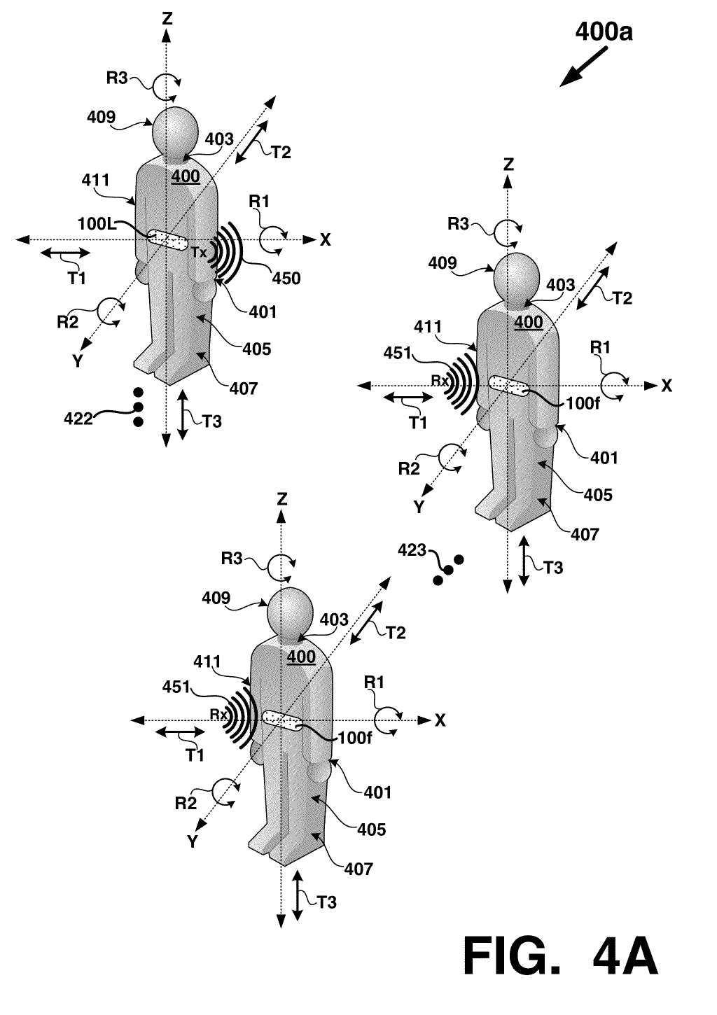

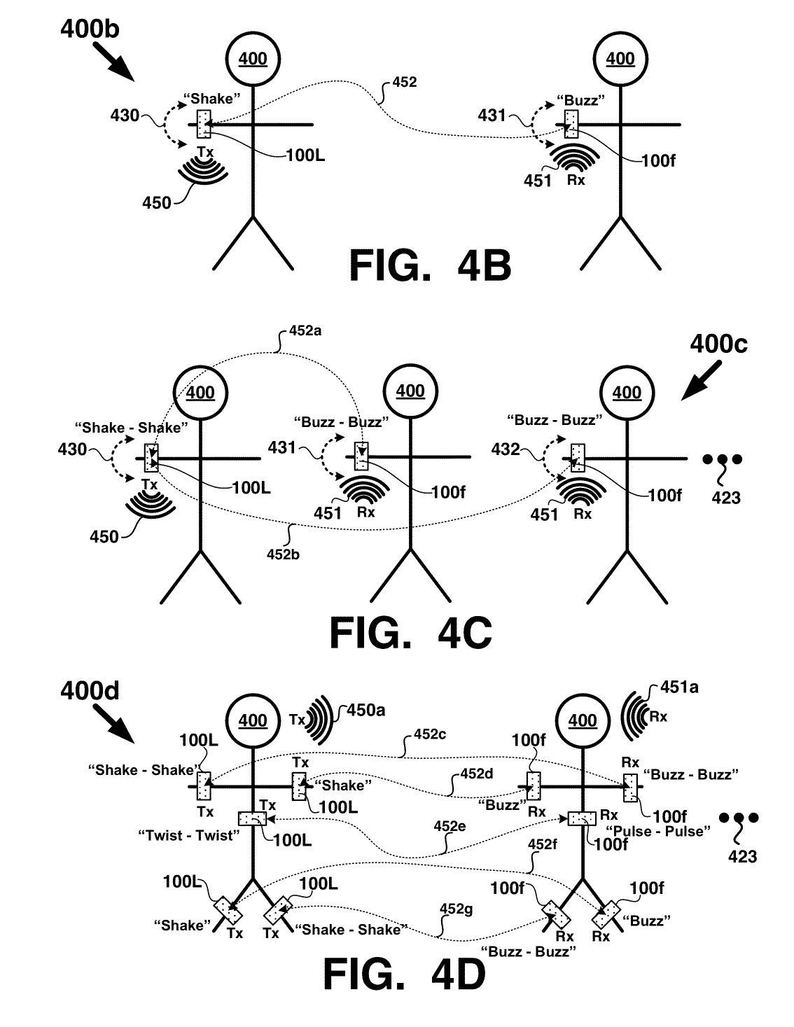

Attention is now directed to FIG. 4A where the device 100 is depicted worn by a plurality of users 400. Device 100 is depicted as being worn approximate a waist of the users 400; however, the position of the device 100 on bodies of the users will be application dependent and is not limited to the configuration depicted in FIG. 4A. Device 100 may be positioned at other locations on user 400's body including but not limited to: wrist 401; neck 403; leg 405; ankle 407; head 409; and arm 411, just to name a few. Moreover, the shape and configuration of housing 199 of the device 100 is not limited to the configuration depicted in FIG. 4A. Sensor system 140 may include one or more sensors configured to generate one or more signals responsive to motion of the users 400. The motion may include but is not limited to rotation (R1, R2, R3) and translation (T1, T2, T3) about X, Y, and Z axes of device 100 as positioned on the body of the users 400. One or more signals from sensors in sensor system 140 may be processed by algorithms (e.g., algorithms from data storage 120) executing on processor 110. The algorithms may analyze the one or more motion signals to determine if the signals are indicative of a motion. Examples of events that may generate motion signals include but are not limited to dancing, exercise, running, walking, athletic activity, sports, fencing, musical performance, swimming, working out, martial arts, drill teams, physical therapy, military training, combat, law enforcement, bicycling, rowing, yoga, just to name a few. Sensor system 140 may include one or more accelerometers, multi-axis accelerometers, gyroscopes or other motion sensing devise to sense and convert motion of user 400 into one or more signals.

In FIG. 4A, one of the users 400 is wearing a device 100 that is configured as a leader device denoted as 100L and the other users 400 are wearing devices 100 configured as follower devices denoted as 100f. The devices 100 may be permanently configured as leader 100L or follower 100f devices, or may be reversibly re-configurable (e.g., via switches 170 or communications interface 130) to be a leader device 100L or a follower device 100f. Although only one user 400 is depicted with leader device 100L, there may be more users 400 and/or leader devices 100L as denoted by 422. Further, although two users 400 having follower devices 100f are depicted there may be more or fewer users 400 and/or follower devices 100f as denoted by 423. Assume for purposes of explanation that user 400 wearing the leader device 100L has been designated as the leader or model for some joint or shared activity among the users 400, including users 400 wearing the follower devices 100f. Moreover, when a device 100 comprises a leader device 100L that device 100 must at least be configured to transmit Tx a RF signal 450 that includes data on motion events caused by motion of user 400's body. Follower devices 100f must at least be configured to receive Rx a RF signal 451 (e.g., the RF signal 450 transmitted Tx by 100L) that includes the data on the motion events so that the data may be processed and related haptic feedback may be generated by haptic system 160 of the follower devices 100f. Here, the haptic feedback generated by the haptic systems 160 of the follower devices 100f may be used to get each of the users 400 wearing the follower devices to synchronize their respective physical motions with that of the user 400 wearing the leader device 100L.

For example, if the joint activity is jumping jacks, then user 400 may lead the exercise activity by performing the necessary physical motions for jumping jacks. Now, motions of user 400's body causes motion signals to generated by sensor system 140 of device 100L and those motion signals are processed (e.g., in processor 110) and output to RF system 135 to be transmitted Tx 450 as motion events that are received Rx 451 at the follower devices 100f. The one or more follower devices 100f process (e.g., by processor 110) the motion events encoded in the RF signal 451 and the processing generates signals that are received by the haptic systems 160 which generates haptic feedback to each of the users 400.

Moving now to FIGS. 4B-4D where additional examples 400b-400d of users wearing leader 100L and follower 100f devices are depicted. In FIG. 4B, a one-to-one scenario 400b includes one user 400 having a single leader device 100L and one user 400 having a single follower device 100f. Leader device 100L and follower device 100f are wirelessly linked 452 with each other. For purposes of explanation, both devices (100L, 100f) are worn a wrist of the users 400, but the one-to-one scenario 400b is not limited to the configuration depicted and the devices may be worn at other locations on the body of the users 400. Motion 430 of leader 400 (e.g., “Shake” of the arm, wrist, body) generates motion signals that are transmitted Tx 450 by device 100L and are received Rx 451 by follower device 100f which generates haptic prompts (e.g., a “Buzz”) which follower 400 may use to imitate, mimic or otherwise duplicate, follow, or synchronize his/her motions with that of leader 400 as denoted by motion 431.

The motions of a leader 400 and one or more followers 400 may broadly include any type of motion, lack of motion, conduct, activity, that may be communicated to follower 400 via a haptic prompt from haptic system 160. For example, leader 400 may be going from a sitting position to a standing position, followed by the leader 400 remaining still or motionless. The follower 400 may mimic the sitting to standing motion via haptic prompts. Moreover, movement by follower 400 absent a motion signal from the leader 400 (e.g., Rx 451 does not include motion data) may generate a haptic prompt to urge follower 400, to become still or motionless in a manner that mimics the motionless state of the leader 400. Therefore, haptic prompts may be in response to motion, absence of motion, or both. Sensor system 140 in follower devices 100f may work in concert with the haptic system 160 in those devices to detect motion of a follower 400, process motion signals caused by the motion of the follower, compare the processed signal with received Rx 451 signals to determine whether or not the leader 400 is moving, and if not, then generate one or more signals that activate the haptic system to generate a haptic prompt intended to urge the follower to remain still or motionless.

In FIG. 4C, a one-to-many scenario 400c depicts a single leader 400 and at least two followers 400. There may be more followers 400 as denoted by 423. Leader device 100L and follower devices 100f are wirelessly linked (452a, 452b) with one another. Here a “shake-shake” motion 430 of leader 400 is wirelessly transmitted by leader device 100L as motion signal Tx 450, follower devices 100f receive Rx 451 the motion signals, and process the motion signals to generate haptic prompts “Buzz-Buzz” that are sensually perceived by followers 400 and may generate motions (431, 432) in followers 400 that may mimic or otherwise approximate the motion of leader 400.

In FIG. 4D, a multiple-leader-device-follower-device scenario 400d may be used for a single leader 400 and a single follower 400 (e.g., a one-to-one scenario) and for a single leader 400 and a multiple followers 400 (e.g., a one-to-many scenario) as denoted by 423. In scenario 400d, leader 400 is wearing five leader devices 100L and each follower 400 is wearing five follower devices 100f. Scenario 400d is not limited to the number of devices (100L, 100F) depicted and may include more or fewer leader 100L and follower 100f devices than depicted. The five leader devices 100L may be positioned at the wrists, abdomen, and ankles of leader 400, for example. Similarly, the five follower devices 100f may be positioned at the wrists, abdomen, and ankles of followers 400, for example. Each leader device 100L may be wirelessly linked 452c-452g with a corresponding follower device 100f. For example, leader devices 100L on wrist of leader 400 may be wirelessly linked 452c with follower devices 100f on wrists of each follower 400, and so on and so forth for the other leader 100L and follower 100f devices, such that the motion signals from a leader device 100L are transmitted Tx to and received Rx by the corresponding follower device 100f. RF signal Tx 450a denotes five different RF signals transmitted Tx by the five leader devices 100L and RF signal Rx 451a denotes five different RF signals received Rx by the five follower devices 100f.

Accordingly, in FIG. 4D the following motions at the different body positions of leader devices 100L are transmitted Tx and received Rx at the appropriate (e.g., linked) follower devices 100f to generate haptic prompts at those devices: via link 452c, a “Shake-Shake” motion at wrist of 100L generates a haptic prompt “Buzz-Buzz” at wrist of 100f; via link 452d, a “Shake” motion at wrist of 100L generates a haptic prompt “Buzz” at wrist of 100f; via link 452e, a “Twist-Twist” at abdomen of 100L generates a haptic prompt “Pulse-Pulse” at abdomen of 100f; via link 452f, a “Shake” motion at ankle of 100L generates a haptic prompt “Buzz” at ankle of 100f; and via link 452g, a “Shake-Shake” motion at ankle of 100L generates a haptic prompt “Buzz-Buzz” at ankle of 100f. In some examples, the same body parts on leader 400 and follower(s) 400 may mapped to each other via the wireless linking by linking a right wrist leader device 100L with a right wrist follower device 100f, for example. Alternatively, a right wrist leader device 100L may be linked with a left wrist follower device 100f, for example. The same linking choices may be applied to other body parts such as ankles, arms, legs, etc.

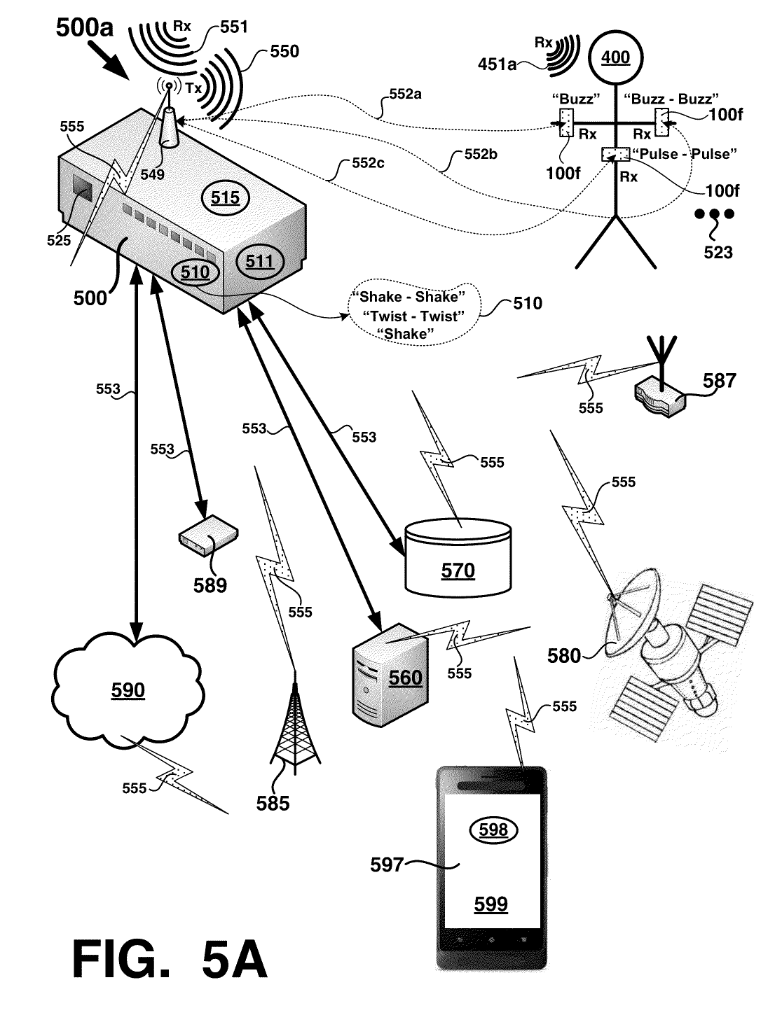

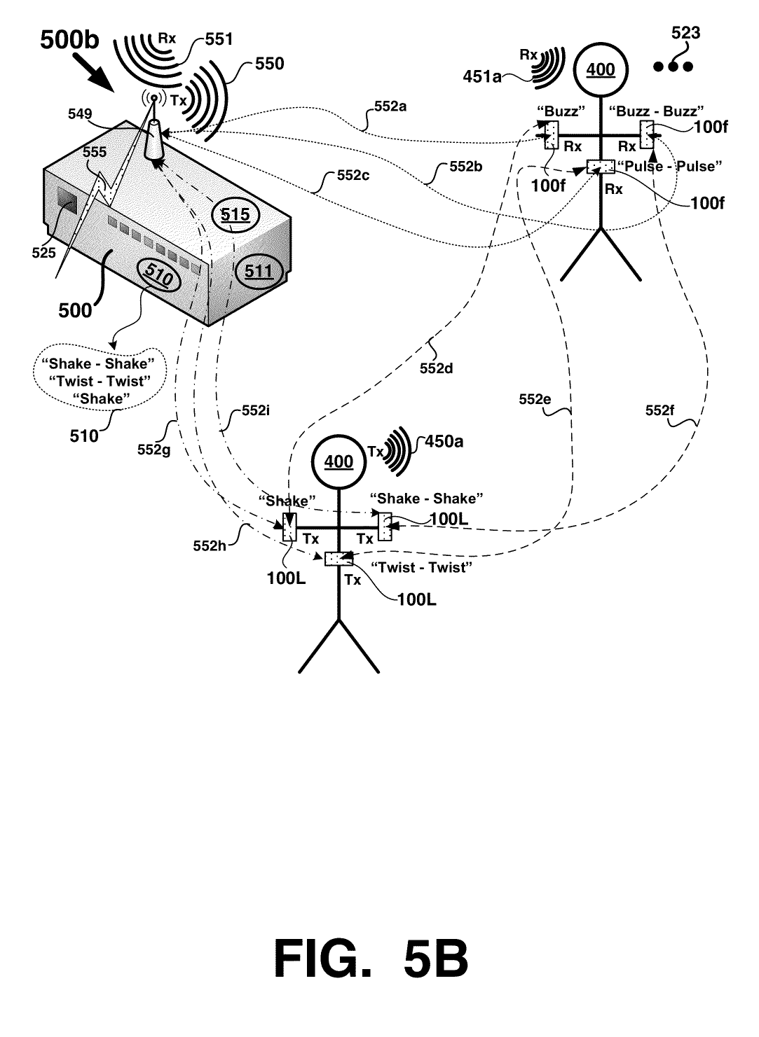

FIG. 5A depicts one example 500a of a wireless media device 500 and one or more follower devices 100f wirelessly linked 552a-552c to one another. There may be more users 400 (e.g., followers) than depicted as denoted by 523 and there may be more or fewer follower devices 100f than depicted. Wireless media device 500 may include a RF system 549 configured to use one or more radios to transmit and/or receive RF signals 555 from external systems, at least one of the one or more radios in RF system 549 is configured to wirelessly communicate Tx 550 and/or Rx 551 with one or more devices 100 that may include follower devices 100f, leader devices 100L, or both. External wireless devices that may be in wireless communication 555 with wireless media device 500 include but are not limited to resource 590 (e.g., Internet, Cloud, ISP, Content Server, website, web page, etc.), a cellular service 585 (e.g., 2G, 3G, 4G, 5G), a server 560 or similar compute engine, data storage 570 (e.g., NAS, RAID, HDD, SSD, etc.), a wireless network 587 (e.g., WiFi, WiMAX, BT, Ad Hoc WiFi, HackRF, USB-powered software-defined radio (SDR), etc.), a communications satellite, either directly or via a service provider (e.g., DIRECTV®, DISH Network®), just to name a few. Wireless media device 500 may also be in data communication (e.g., via Ethernet, LAN, WAN, WiFi, WiMAX, BT, Ad Hoc WiFi, HackRF, USB-powered software-defined radio (SDR), etc.) with external devices including but not limited to resource 590, modem 589 (e.g., cable modem), server 560, data storage 570, just to name a few.

Wireless media device 500 may serve several roles with respect to devices 100. When the device 100 comprises one or more follower devices 100f, or devices 100 than are reversibly re-configurable to be follower 100f or leader 100L devices, transmitted data Tx 550 that generates the haptic prompts on the follower devices 100f may be generated by media device 500 using content 510. The content 510 may include but is not limited to music, sound, a sound track from a movie or video, a voice recording, just to name a few. Content 510 may be data captured from one or more leader devices 100L and stored in a format that when played back (e.g., decoded or processed) by media device 500 generates a RF signal Tx 550 that includes the equivalent of the motion signals from leader devices 100L that when received Rx by follower devices 100f, generates the haptic prompts on the follower devices 100f.

Content 510 may be streamed to media device 500 using any of the wireless 555 or wired 553 communications links described above or other communications resources. Content 510 may be included in a data storage system 515 of the media device 500 (e.g., ROM, RAM, FLASH, DRAM, SRAM, SSD, HDD, etc.) or reside in a data storage device 511 that is accessed by the media device 500, such as in a memory card (e.g., SD, microSD, SDHC, SDXC, MMS, Flash, SSD). The data storage device 511 may be configured to be inserted into a slot, a bay, or the like in media device 500 to enable electronic accesses to the data storage device 511.

In some examples, content 510 may be accessed wirelessly 555 or wired using the communications links described above and then be streamed, buffered, or stored in media device 500. For example, content 510 may be accessed from a variety of sources including but not limited to resource 590, server 560, data storage 570, cellular service 585, wireless network 587, modem 589, or communications satellite 580. Content 510 may be media in a variety of forms including but not limited to compressed data formats, uncompressed data formats, lossless compression formats, lossy compression formats, MP3, MPEG, WAV, AIFF, FLAG, Apple Lossless, ATRAC, PCM, WMA Lossless, WMA Lossy, ATRAC, and RAW formats, just to name a few. In other examples, content 510 may comprise data from a live event, performance, contest, conference, broadcast, presentation, demonstration, activity, or the like.

In FIG. 5A, one or more follower devices 100f and one or more followers 400 may be interactive with media device 500. Here, follower 400 is wearing three follower devices 100f, one on each wrist and one about the waist. Although follower devices 100f are depicted, the device 100 may be reversibly re-configurable to be follower 100f or leader 100L devices, but for purposes of explanation a follower device 100f will be described. Now, each follower device 100f is wirelessly linked 552a-552c with RF system 549 of media device 500 and therefore each follower device 100f is enabled to receive Rx 451a the transmitted data stream comprising the motion signals as denoted as Tx 550. Content 510 may include data comprising motion signals or an equivalent that are operative to generate haptic prompts on devices 100, such as follower devices 100f. Therefore, the transmitted Tx 550 RF signal includes motion data such as “Shake-Shake”, “Twist-Twist”, and “Shake” and that data when received Rx 451a by the RF systems 135 of the follower devices 100f is processed and generates haptic prompts in the corresponding follower device 100f such that the “Shake-Shake” generates a “Buzz-Buzz” haptic prompt in the wrist mounted follower device 100f, the “Twist-Twist” generates a “Pulse-Pulse” haptic prompt in the waist mounted follower device 100f, and the “Shake” generates a “Buzz” haptic prompt in the other wrist mounted follower device 100f. As denoted by 523, there may be more followers 400 with their follower devices 100f that are linked with media device 500.

In some applications the motion signals in content 510 may be derived from or be directly based on actual motion signals generated by one or more leader devices 100L and recorded or otherwise captured and rendered into content 510. In other applications, content 510 may include data from music, dance, choreography, or other form of expression that may or may not include rhythmic and/or syncopated beats, prompts, pulses, cues, etc. As one example, content 510 may comprise hip-hop music which may include one or more elements of beats, rhythms, syncopation, or the like that may be extracted from the music or other source and processed into a motion signal format configured to map one or more of the elements to haptic prompts for one or more follower devices. As one example, media device 500 may be configured to analyze content 510 in the digital domain, the analog domain, or both and determine where a rhythmic pulse exists in the content 510 (e.g., a bass line in music) and then generate motion signals that are transmitted Tx 550 to one or more devices 100 (e.g., follower devices 100f). Algorithms running on a processor (e.g., DSP, μP, μP, ASIC) in media device 500 may be used to determine if content 510 includes the rhythmic pulse by analyzing low frequency content, period, decibel levels of the rhythmic pulse, repetition of the rhythmic pulse, etc. The algorithms may reside in a non-transitory computer readable media in data storage system 515.

Content 510 and/or media device 500 may be configured to be adaptable to different use scenarios where the number of followers 400, the number of follower devices 100f worn by each follower 400, and positions of the follower devices 100f on the body of each follower 400 may be programmed and be modifiable as the use scenario changes. In FIG. 5A, an external wireless user device 599 (e.g., a smartphone, tablet, or pad) may be in communication 555 with media device 500. A display 597 of user device 599 may include a GUI for an application (APP) 598 that interfaces with media device 500 and may be used to configure the setup and operation of content 510 with one or more followers 400 and one or more follower devices 100f per follower 400. For example, APP 598 may configure the media device 500 to link with twenty follower devices 100f for four followers 400, each follower 400 wearing five follower devices 100f. As one example, if follower 400 has only one follower device 100f configured to be worn about the waist, the APP 598 may configure media device 500 to link 552c with the waist mounted follower device 100f and motion signals in content 510 directed toward waist motion may be processed by media device 500 and transmitted Tx 550 to follower device 100f, such that the “Twist-Twist” generates a “Pulse-Pulse” haptic prompt in the waist mounted follower device 100f. As another example, if follower 400 acquires two more follower devices 100f for use on each wrist, and now has three follower devices 100f, then the APP 598 may reconfigured media device 500 to link (552a, 552b) with the two wrist mounted follower devices 100f. With the addition of the two follower devices 100f, additional motion signal information in content 510 may be mapped to the added follower devices 100f, such that the “Shake-Shake” generates a “Buzz-Buzz” haptic prompt in the wrist mounted follower device 100f, the “Twist-Twist” generates a “Pulse-Pulse” haptic prompt in the waist mounted follower device 100f, and the “Shake” generates a “Buzz” haptic prompt in the other wrist mounted follower device 100f. In some applications, configuring the media device 500 for operation with devices 100 may be accomplished using an interface on the media device 500, using an external device (e.g., user device 599), or both.

Media device 500 may include one or more speakers 525 configured to generate sound from playback of content 510. An audio system of the media device 500 may include speaker 525 and associated audio amplifiers (e.g., Class D amplifiers) electrically coupled with speaker 525. The audio system may include one or more microphones to capture sound and/or serve as sound sensors. Media device 500 may include one or more processors, a power system, data storage (e.g., Flash memory), and a communications interface for wired communications (e.g., Ethernet, UUSB, etc.), wireless communications, or both. The communications interface may include a plurality of different radios and associated antennas for wireless communications using different wireless protocols (e.g., Bluetooth, NFC, WiFi, WiMAX, Ad Hoc WiFi, Cellular, 2G, 3G, 4G, 5G, HackRF, USB-powered software-defined radio (SDR), and any variety of 802.11, etc.). One or more followers 400 may listen to the content 510 being playback and may also receive haptic prompts generated by the media device 500 as described above. Listening to the playback of content 510 while also receiving haptic prompts may allow the followers to more easily synchronize their movements (e.g., as in dancing to music) to the content 510 and their movements may by synchronized to one or more pulse elements in content 510 (e.g., a beat or bass line in content 510).

Attention is now directed to FIG. 5B where one example 500b of a wireless media device 500 wirelessly linked with leader 100L and/or follower 100f devices is depicted. A leader 400 may wirelessly link 552d-552f three of his/her leader devices 100L with three follower devices 100f as was described above. Here, leader 400 and one or more followers 400 may listen to the playback of content 510 over speaker 525 and movement of leader 400 in response to the playback (e.g., of music) may be used to generate the motion signals from leader devices 100L that are transmitted Tx 450a to the corresponding follower devices 100f as described above. Therefore, the followers 400 attempt as best as possible to match their responding motions to those of the leader 400 by reacting to the haptic prompts generated by their follower devices 100f.

In FIG. 5B, leader devices 100L may be wirelessly linked 552g-552i with media device 500 in a manner similar to that described above for follower devices 100f. In one example, the leader 400 may listen to content (e.g., music) being played back over speaker 525 and then in reaction to the content (e.g., moving to the beat etc.) generate motion signals (e.g. by dancing or exercising) from each leader device 100L and those motion signals may be transmitted Tx 450a to media device 500 as a received Rx 551 RF signal that is processed by media device 500 to generate content 510. The content 510 may be stored in data storage system 515 for later playback to followers 400 wearing follower devices 100f as described above. For example, a motion stream from the leader devices 100L generate by motion of leader 400 may be recorded or otherwise captured and then processed by media device 500 to generate data formatted to form a motion signal format that is stored as the content 510. Content 510 may comprise a file or other data structure that includes data representative of the “Shake-Shake”, Twist-Twist”, and “Shake” motions of leader 400.

Alternatively, in FIG. 5B both the leader 400 and one or more followers 400 may listen to playback of content from media device 500 and the follower devices 100f may generate haptic prompts based on received motion signals from the leader devices 100L via wireless links 552d-552f or from the media device 500 via wireless links 552a-552c. The media device 500 may transmit motion signals using content 510 as the source or using motion signals from the leader devices 100L via wireless links 552g-552i. When the leader devices 100L are the source of the motion signals, the media device may receive the motion signals via wireless links 552g-552i and re-transmit then to the follower devices 100f via wireless links 552a-552c. When the leader devices 100L are the source of the motion signals received by the follower devices 100f, the media device 500 may record or otherwise capture the motion signals via wireless links 552g-552i to generate content 510.

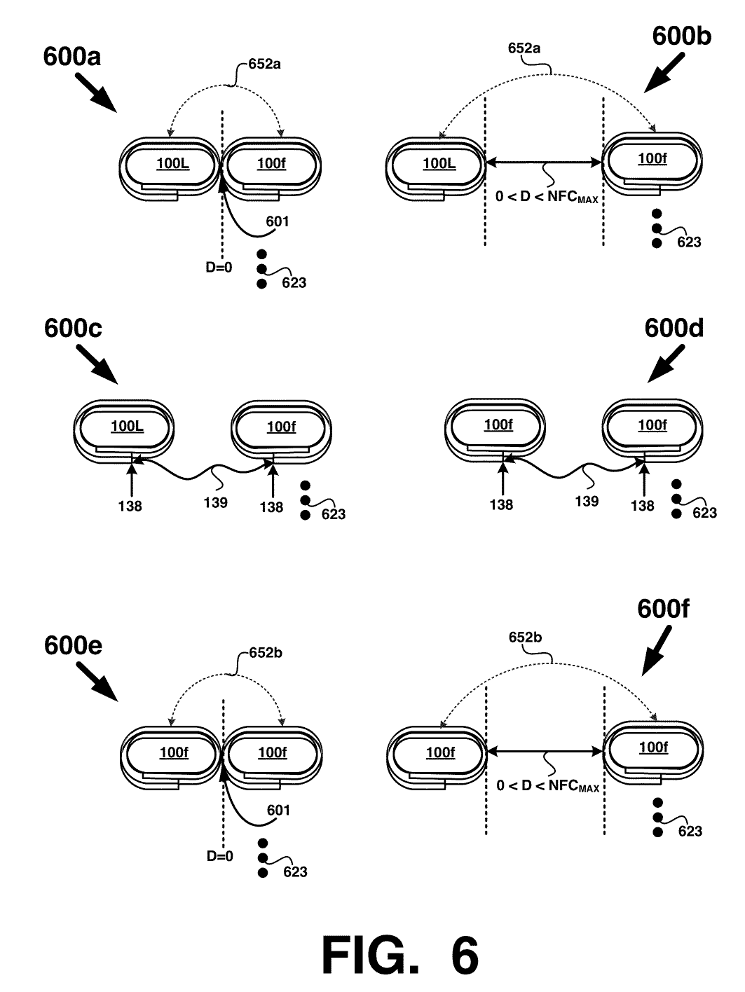

Moving on to FIG. 6 depicts several examples of how devices 100 (e.g., 100L, 100f) may be wirelessly linked with one another. For purposes of explanation it may be assumed that each device 100 has been powered up or otherwise activated for wireless linking (e.g., placed in pairing mode or some other mode). In example 600a, a leader device 100L and a follower device 100f may be positioned in direct contact with each other such that a distance D between the two devices is 0 (zero). Here, leader device 100L and follower device 100f may directly contact or otherwise touch each other at some position 601 on their respective housings 199. When D=0 each device (100L, 100f) is in very close proximity with each other and the RF systems 135 of each device may recognize each other via RF signals from one or more of their respective radios and initiate a linking or paring operation that establishes a wireless link 652a between the devices (100L, 100f). Switches 170 may be used to place each device (100L, 100f) into a link mode were it may link with other devices. Indicators 180 and/or display 137 may provide status indicators as to entry into link mode and may verify successful linking between devices (100L, 100f). If devices (100L, 100f) are configured for near field communication (NFC), then distance D may easily satisfy the minimum required distance between devices (100L, 100f) for NFC for linking or other wireless communication purposes. More than one device (100L, 100f) may be linked, paired or otherwise with other devices (100L, 100f) as denoted by 623.

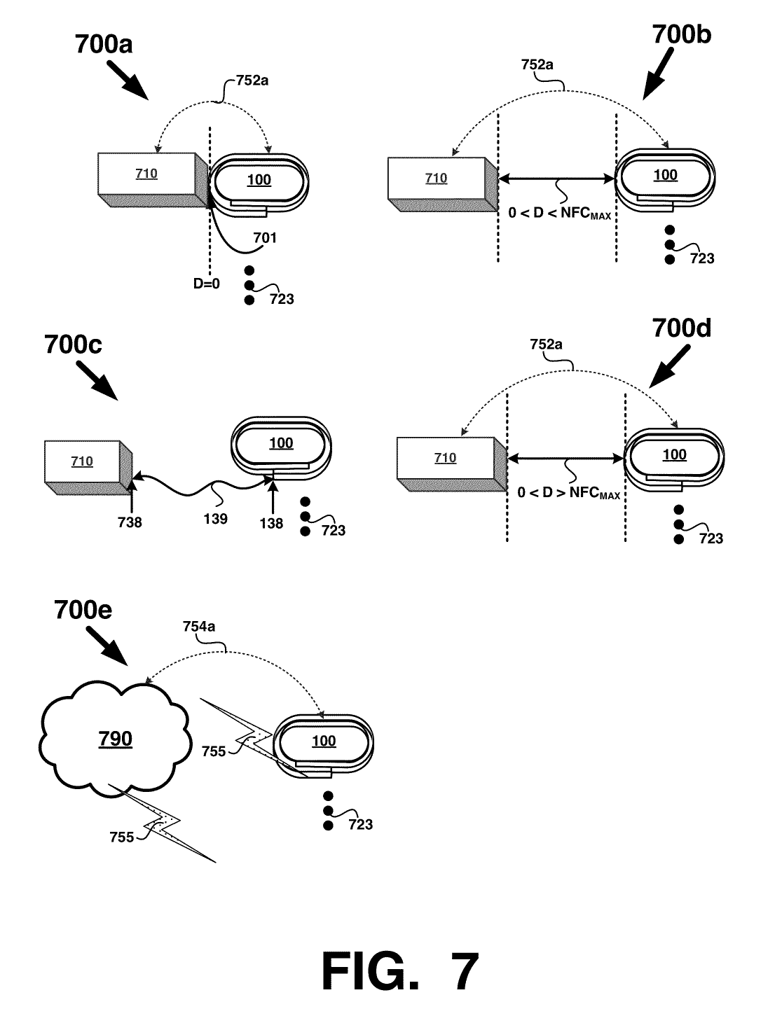

Although leader 100L and follower 100f devices are depicted, the link 652a may be accomplished in a similar manner for a link 652a between two leader devices 100L or two follower devices 100f. Each follower device 100f that is linked 652a with the leader device 100L may be assigned the same function or be assigned different functions. As one example, consider one leader device 100L is used to establish links with five follower devices to be worn on the left wrist of five followers 400. Each of the five follower device 100f is assigned the left wrist function (e.g., a haptic channel) that corresponds with a left wrist leader device worn on the left wrist of a leader 400. A haptic channel may comprise a one-to-one wireless linking between a specific leader device 100L and one or more follower devices 100f that may be positioned on the followers bodies at the same location as the leader device 100L is positioned on the leader's body. As another example, consider one leader device 100L is used to establish links with five follower devices to be worn on the left and right wrists, the waist, and the left and right ankles of a follower 400. The first follower device 100f is assigned the left wrist haptic channel, the second follower device 100f is assigned the right wrist haptic channel, the third follower device 100f is assigned the left ankle haptic channel, the fourth follower device 100f is assigned the right ankle haptic channel, and the fifth follower device 100f is assigned the waist haptic channel. As yet another example, there may be five leader devices 100L for five haptic channels comprising the left and right wrists, the waist, and the left and right ankles of a leader 400 and each follower device 100f is linked with its corresponding leader device 100L by bringing those devices into contact with one another or by other methods such as described in regards to FIGS. 6 and 7. Accordingly, the left wrist follower device 100f may be linked with the left wrist leader device 100L and so on and so forth for the remaining four leader 100L and follower devices 100f. In some applications, a device other than a leader device 100L transmits the haptic channels that follower devices 100f are wirelessly linked with (e.g., wireless media device 500 or other wireless device).

Example 600b depicts an scenario where the wireless link 652a is established when the devices (100L, 100f) are not in contact with each other but are spaced apart by the distance D, where D is greater than 0 and less than a maximum allowed NFC distance NFC_{MAX}. Here, if distance D is greater than NFC_{MAX}, then wireless linking may be unreliable or impossible due to factors including but not limited to reduced RF signal strength when D is greater than D is greater than NFC_{MAX}, RF interference from other RF sources, just to name a few. In some examples, NFC_{MAX} may be D greater than 1 meter. In other examples, NFC_{MAX} may be D greater than 0.3 meters. Actual values for D and NFC_{MAX} may be application dependent and the foregoing are non-limiting examples only. The devices 100 are not limited to using NFC and its related protocols and NFC is just one example of how the devices 100 may wirelessly communicate with one another. Other wireless communication protocols such as Bluetooth and 801.11 and its variants, just to name a few. Distance D may be much greater than is typical for NFC, such as 10 meters for Bluetooth and much greater than 10 meters for 801.11 and its variants, for example.

Examples 600c and 600d depict using data port 138 and connection 139 (e.g., a USB or other type of cable) to establish a hard wired link between devices 100, such as between a leader 100L and follower 100f (in 600c) or between two followers 100f (in 600d). Examples 600e and 600f depict wireless linking 652b between follower devices 100f in a manner similar to that described above for examples 600a and 600b. After a device 100 (e.g., 100L, 100f) has been linked wirelessly or via hardwire, a haptic channel assignment or other data in a previously linked device 100 may be transferred to another device 100 in by linking with that device 100. Take for instance the example 600c where leader device 100L make a hard wired link with follower device 100f. Assume for purpose of explanation, that leader device 100L assigns the follower device 100f a right ankle haptic channel because the leader 400 will be wearing the leader device 100L on his/her right ankle. Now in example 600d, the follower device 100f on the left is the one that was assigned the right ankle haptic channel via the hardwired link with leader device 100L. The follower device 100f on the right of example 600d is then linked via hardwire with the previously linked follower device 100f on the left and the result of the link may be assigning the right ankle haptic channel to the follower device 100f on the right, so that both follower devices 100f are assigned the right ankle haptic channel. This process may be repeated by linking (wirelessly or wired) a previously linked device with an un-linked device. Therefore, if leader 400 is going to lead ten followers 400 in an exercise routine requiring a follower device on the right ankle of each follower 400, then only one of the follower devices 100f need link with the leader device 100L and the remaining nine follower devices may link with any previously linked follower device 100f and be assigned the right ankle haptic channel. When the exercise routine begins, motion signals from the right ankle mounted leader device 100L will be wirelessly transmitted as described above to each of the ten follower devices 100f.

FIG. 7 depicts several examples of how devices 100 may be wirelessly linked with external devices 710. External device 710 may be the wireless media device 500 of FIGS. 5A-5B, the external devices depicted in FIG. 5A (e.g., 599, 560, 570, 587, 585, 590, etc.) but is not limited to those examples. In FIG. 7 device 100 may be a leader device 100L, follower device 100f, or both. There may be more than one device 100 as denoted by 723. As was described above in regards to the examples depicted in FIG. 6, linking between the external device 710 and device 100 may be via direct contact (e.g., D=0) as depicted in example 700a, by close proximity (e.g., NFC) as depicted in example 700b, via a hardwired connection (138, 139) as depicted in example 700c, and via wireless link over a longer distance than typical of NFC or its equivalents (e.g., Bluetooth and/or WiFi) as depicted in example 700d where D>NFC_{MAX}. In other examples, one or more radios in device 100 may establish a link 754a with a resource 790 (e.g., Cloud, Client Device, Endpoint, Internet, web site, Content Server, web page, etc.) using wireless communications 755 to establish link 754a. As was described above in reference to FIG. 6, after a device 100 is linked with and external device 710 or resource 790, un-linked devices 100 may be linked to the external device 710 or resource 790 by linking with a previously linked device 100 and may receive haptic channel assignments, configuration, or other data from the previously linked device 100.

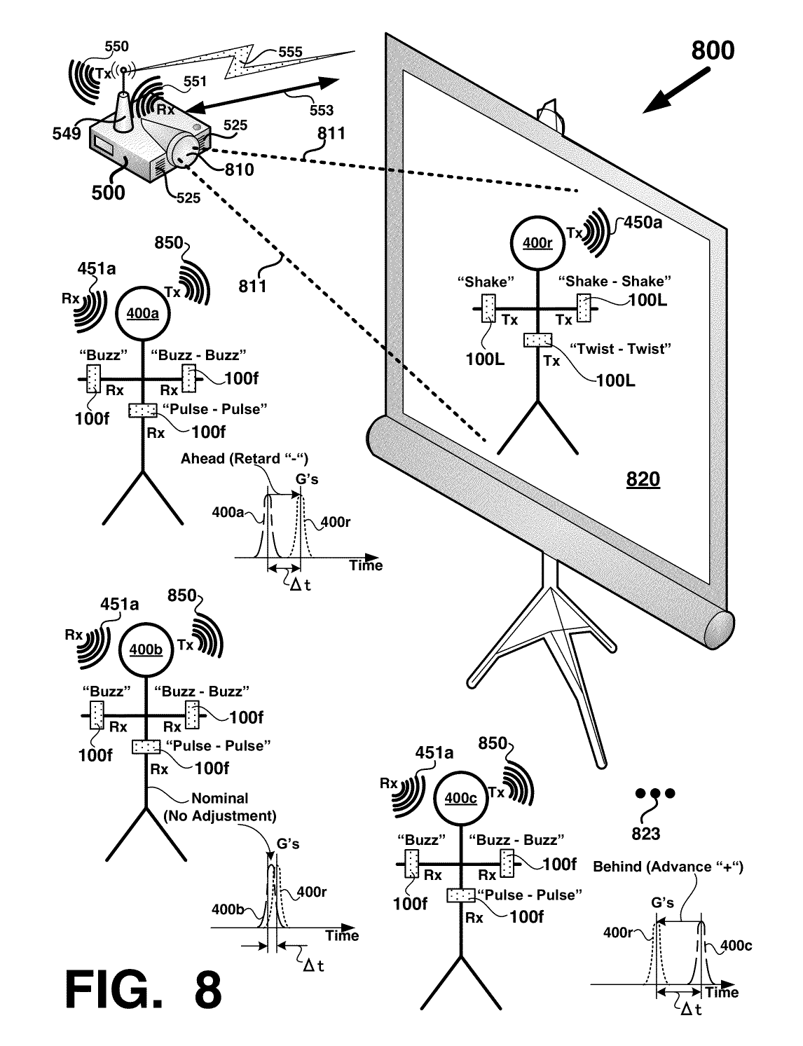

FIG. 8 depicts one example of a remote session 800 and optional advancing or retarding haptic prompts. In FIG. 8 wireless media device 500 may include a display system 810 such as a projector (e.g., DLP, LED, Pico-projector, micro-projector, or the like) or wireless media device 500 may be coupled (e.g., via HDMI or Component Video) to a display device such as a projector, HDTV (e.g., Plasma or LED). Display 810 projects an image 811 of a leader 400r on a screen 820. An image and/or sound of leader 400r may be captured (e.g., via audio/video recording) at a remote location (e.g., out of the presence of followers 400a-400c) and broadcast (e.g., via communications satellite 580) to media device 500 using wired 553 or wireless 555 communications, from sources such as those discussed above in reference to FIG. 5A or the image and/or sound of leader 400r may be in the form of content 510 resident on or accessible by media device 500. Broadcast of leader 400r and/or content 510 may be live, time delayed, or pre-recorded, for example. Here, leader 400r may be leading an exercise routine that is to be mimicked or otherwise replicated by similar motions of one or more followers 400a-400c. Although three followers 400 are depicted there may be more or fewer as denoted by 823. Motion signals generated by the three leader devices 100L worn by leader 400r are collectively transmitted Tx 450a (e.g., over a communications network such as WiFi or other) and received 555 by media device 500. Video content of leader 400r is processed by media device 500 and displayed using display system 810 as the image 811 on screen 820, audio content is processed and played back on one or more speakers 825, and motion signal content is wirelessly transmitted Tx 550 by RF system 549 and received Rx 451a by the corresponding follower devices 100f of each follower 400a-400c to generate the appropriate haptic prompts in each follower device 100f as described above. The motion signals from the leader devices 100L may be received by another media device 500 (not shown) or some other wireless system (not shown) in proximity to or in the same location as the leader's 400r performance and that device or system may use it communications resources and system to wirelessly transmit 555 the content comprised of the video, audio, and motion signals to media device 500. In other examples, the content comprised of the video, audio, motion signals and other data have been recorded or otherwise stored as content 510 and media device 500 plays back the content 510 using speakers 525, display system 810, and RF system 549 as described above in reference to FIGS. 5A-5B.

FIG. 8 also depicts a scenario where the three followers 400a-400c may have different reaction times to the haptic prompts generated by their follower devices 100f in response to the leader's 400r motion signals. In that each device 100 (e.g., 100L, 100F or both) may include the sensor system 140, each haptic prompt generated by a follower device 100f and/or by motion of the followers 400a-400c as they respond to the haptic prompts may generate motion signals that may be analyzed internally in device 100 (e.g., using processor 110) to determine how close in time the generation of the haptic prompt is to the motion by the follower in response to the haptic prompt. If a followers motion is out of synch with the haptic prompts for one or more of the follower devises 100f being worn, the analysis of the motion signals and haptic prompts may be used to advance or retard the generation of haptic prompts at the appropriate follower device 100f.

As one example, a graph of G-force over time for follower 400a depicts a motion signal for follower 400a occurring earlier in time compared to motion signal from leader 400r, such that there is time difference Δt between the peaks of those two signals that is indicative of follower 400a anticipating the haptic prompt(s) from one or more of his/her follower devices 100f and is therefore moving ahead of the leader's 400r motion signal. Processor 110 may analyze both signals and may command the haptic interface 160 to delay generating haptic prompts at one or more of the follower devices 100f. The adding of delay may retard the propensity of follower 400a to anticipate the haptic prompt such that the peak for motion signal for 400a moves forward in time and closer to or in alignment with the peak for motion signal 400r, thereby reducing time difference Δt between the peaks of those two signals to a nominal value. The nominal value may be Δt=0 or Δt=+/−some time value, such as tenths or hundredths of a second, for example.

As another example, a graph of G-force over time for follower 400b depicts a motion signal for follower 400b occurring within a window for Δt that is nominal relative to the peak for the motion signal for 400r. That is, Δt may not be exactly zero but is within an acceptable range of values (e.g., +/−100 milliseconds) for the activity being performed. Different activities may have different tolerances for nominal values of Δt. Therefore, the adding of delay to retard the motion responses of follower 400a may include moving the peak for 400a closer to that of 400r as depicted for follower 400b.

As yet another example, follower 400c is moving after the peak of motion signal 400r as depicted by motion signal peak for 400c. In contrast to the adding of delay to retard the early motion response of follower 400a, for follower 400c the analysis by processor 110 may advance the generation of haptic prompts from haptic interface 160 to urge follower 400c to move earlier so that the motion peak for 400c moves backward in time towards the peak for 400r into a nominal range as depicted for follower 400b. Instead of or in addition to generating haptic prompts that are advanced or retarded, the haptic interface 160 may generate a warning haptic prompt (e.g., a specific vibrational force or pattern) that is either indicative of the follower moving to soon or moving too late. There may be one type of warning haptic prompt to warn followers 400 that they are moving too late and another type of warning haptic prompt to warn followers 400 that they are moving too early.

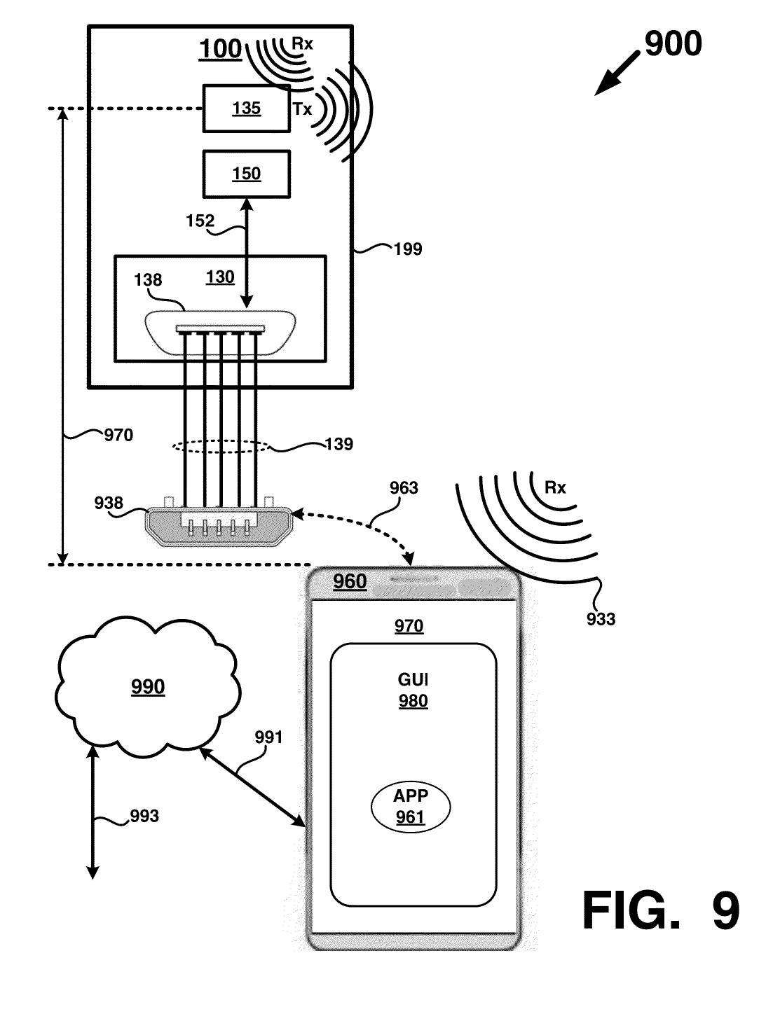

FIG. 9 depicts one example of a data port 138. Here, data port 138 may be a USB port, such as a micro or mini USB port, for example. An electrical connection 139 may be made with the port 138 and another port 938 connected 963 with an external device 960 (e.g., a pad, tablet, PC, or smartphone). A USB cable or the like may be used for connection 139. The present application is not limited to using a USB cable and USB connectors for port 138 and other connectors and communication ports may be used. Data transmitted by communications interface 130 may be communicated using the data port 138, the RF system 135, or both. Connection 139 and ports 138 and 938 may be used for data communication between device 100 and external device 960 and/or for supplying electrical power to power system 150. External device 960 may detect (e.g., receive Rx 933) RF transmission Tx from device 100 when the two devices are at least within distance 970 of each other or in direct contact with each other. Distance 970 may represent a near field distance that enables near field communication between devices 100 and 960 and/or a distance sufficient for the low power RF signal transmitted Tx by device 100 to be detected and reliably received by a RF system of external device 960. Distance 970 may be the distance D described above in regards to FIGS. 6 and 7. Device 100 (e.g., leader device 100L, follower device 100f, or both) may wirelessly communicate with one or more radios in RF system 135 configured for longer range RF communications, such as a Bluetooth radio, a WiFi radio, WiMAX, HackRF, USB-powered software-defined radio (SDR), and an Ad Hoc WiFi radio, for example. WiFi and/or WiMAX may include any variety of IEEE 802.11 protocol (e.g., 802.11a, b, g, n, ac, ad, or others).

External device 960 may be in data communication 991 with an external resource 990 (e.g., the Cloud, Content Server, web page, web site, Internet) via wireless communication (e.g., WiFi, HackRF, USB-powered software-defined radio (SDR), Cellular, 2G, 3G, 4G, 5G) or wired communications link (e.g., Ethernet, LAN, WAN, etc.). External resource 990 may be in data communications 993 with other systems, such as data storage, servers, and communication networks, for example. External device 960 may include a display 970 that presents a GUI 990 or other interface for communicating information to a user of the external device 960. An application (APP) 961 executing on a processor of device 960 may be configured to communicated with and control one or more functions and/or systems in device 100. External device 960 may communicate some or all of data received from device 100 (e.g., Rx 933 may comprise transmitted Tx motion signals) to another system, such as resource 990 or other. Data port 138 may be used to perform diagnostics on device 100, to update or replace data in data storage 120, to update or replace an operating system (OS) or algorithms in device 100, just to name a few. In some examples, RF system 135 may be configured to receive Rx RF signals from the external device 960 or other RF sources.

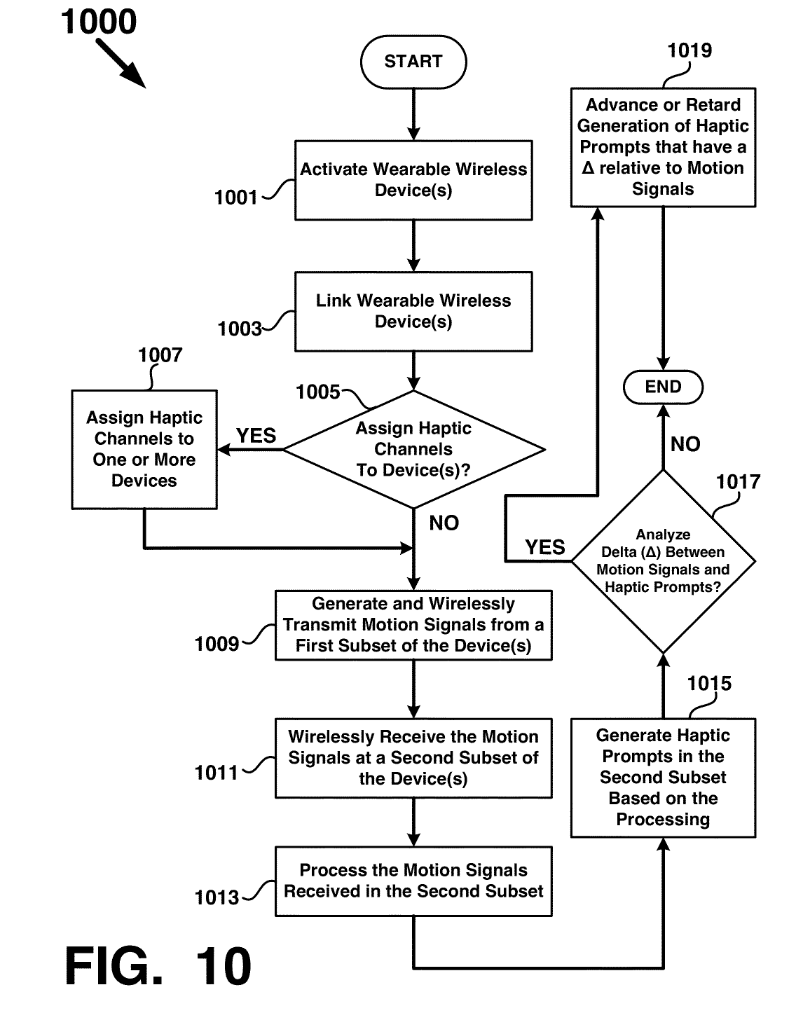

FIG. 10 depicts one example of a flow diagram 1000 for a wearable wireless device 100. At a stage 1001, one or more wearable wireless devices 100 (e.g. 100L and/or 100f) may be activated. Activation may comprises powering up, booting up, or otherwise bringing online the devices 100 in preparation for using the devices 100 with each other or with a media device (e.g., wireless media device 500) or some other system, client, or endpoint, including but not limited to those depicted in FIGS. 5A, 5B, 7 and 8.

At a stage 1003, devices 100 may be linked using the wireless linking and/or hard wired linking described above and in reference to FIGS. 6 and 7. In some examples, one or more follower devices 100f are linked with one or more leader devices 100L. In other examples, one or more follower devices 100f may be linked with an external device that is not the device 100, such as those described above in FIGS. 5A, 5B, 7 and 8. In another example, one or more leader devices 100f may be linked with an external device that is not the device 100, such as those described above in FIGS. 5A, 5B, 7 and 8. In yet another example, a plurality of leader devices 100L may be linked with one another. In still another example, a plurality of follower devices 100f may be linked with one another. At a stage 1005 a determination may be made as to whether or not to assign haptic channels to one or more of the linked devices. If a YES branch is taken, then the flow 1000 transitions to a stage 1007 were haptic channel are assigned to devices 100 (e.g., from one or more leader devices 100L to one or more follower devices 100f). If a NO branch is taken, then the flow 1000 transitions to a stage 1009 were motion signals are generated and wirelessly transmitted from at least one device 100 (e.g., a leader device(s) 100L, media device 500, external device, or the like) as described above. At the stage 1009, a plurality of devices 100 may have been activated and linked at the stages 1001 and 1003, and a first subset of the plurality of devices 100 (e.g., leader devices 100L or media device 500) generates and wirelessly transmit motion signals. The generating and wirelessly transmitting at the stage 1009 may be split up into more than one stage, such as a motion signal generation stage followed by a wireless transmission stage. At a stage 1011 the transmitted motion signals are received at one or more follower devices 100f as described above. The devices 100 receiving the motion signals at the stage 1011 may be a second subset of the plurality of media devices 100 that were activated and linked at the stages 1001 and 1003. At a stage 1013 each follower device 100f (e.g., second subset of devices) may process the motion signals it received using its processor 110, for example. The processing may include algorithms fixed in a non-transitory computer readable medium (e.g., data storage 120) and configured to execute in processor 110. At a stage 1015 haptic prompts (as describe above) are generated by the haptic interface of each follower device 100f (e.g., second subset of devices) based on the processing done by that follower device 100f. Flow 1000 may terminate after the stage 1015.

Optionally, a stage 1017 may include analyzing a difference (e.g., a delta Δ) between motion signals received by and haptic prompts generated by the follower device 100f to determine if a user wearing the follower device 100f is moving in synchronized motion with the transmitted motion signals that were received and processed by the follower device 100f. If follower device 100f motion signals occur in time before the haptic prompt, the follower device 100f may add delay to the generation of haptic prompts (e.g., in haptic interface 160) in attempt to retard the early movement of the user (e.g., user 400a). On the other hand, if follower device 100f motion signals occur in time after the haptic prompts, then the follower device 100f may hasten in time the generation of haptic prompts (e.g., in haptic interface 160) in attempt to advance the late movement of the user (e.g., user 400c). If the time difference between the motion signal and the haptic prompt in the follower device 100f is in a nominal range, then no action may be taken by the follower device 100f to modify the timing of generation of haptic prompts (e.g., user 400b).

In some examples, using motion signals generated by sensor system 140 in a follower device 100f may be compared with the generation of haptic prompts in that follower device 100f to determine if the follower's motion is ahead of or behind the motion of the leader whose leader device(s) are transmitting the motion signals. Acceleration data (e.g., g forces) generated by the sensor system 140 may be processed and compared with the mechanical impulses that comprise the haptic prompts or the electrical signals outputted by the haptic interface 160 to generate the mechanical impulses that are felt by the follower as haptic prompts.

In other examples, information in the actual motion signals (e.g., amplitude, waveform, timing, pulse shape, period, etc.) transmitted by the leader device 100L and received in the follower device 100f may be analyzed and compared with the mechanical impulses that comprise the haptic prompts or the electrical signals outputted by the haptic interface 160 to generate the mechanical impulses. The analysis may be used to determine if the follower's motion is ahead of or behind the motion of the leader as described above. In yet other examples, the motion signals transmitted by the leader device 100L (e.g., in first subset) and received in the follower device 100f and the motion signals generated by sensor system 140 in the follower device 100f may be used in the analysis to determine if there is a Δ between the motion signals and haptic prompts as described above and command (e.g., via haptic interface 160) an advancing or retarding of haptic prompt generation accordingly. The follower devices 100f may be in the second subset of devices 100 as described above.

If the NO branch is taken at the stage 1017, then the flow may terminate. On the other hand, if the YES branch is taken, then the flow 1000 may transition to a stage 1019 where the generation of haptic prompts by haptic interface 160 may be advanced or retarded based on the above mentioned analysis (e.g., using processor 110) determining that there is a Δ between the motion signals and haptic prompts as described above. As before, the motion signals may be derived from the sensor system 140 of the follower device 100f, the motion signals received by the RF system 135 of the follower device 100f, or both.

The systems, devices, apparatus and methods of the foregoing examples may be embodied and/or implemented at least in part as a machine configured to receive a non-transitory computer-readable medium storing computer-readable instructions. The instructions may be executed by computer-executable components preferably integrated with the application, server, network, website, web browser, hardware/firmware/software elements of a user computer or electronic device, or any suitable combination thereof. Other systems and methods of the embodiment may be embodied and/or implemented at least in part as a machine configured to receive a non-transitory computer-readable medium storing computer-readable instructions. The instructions are preferably executed by computer-executable components preferably integrated by computer-executable components preferably integrated with apparatuses and networks of the type described above. The non-transitory computer-readable medium may be stored on any suitable computer readable media such as RAMs, ROMs, Flash memory, EEPROMs, optical devices (CD, DVD or Blu-Ray), hard drives (HD), solid state drives (SSD), floppy drives, or any suitable device. The computer-executable component may preferably be a processor but any suitable dedicated hardware device may (alternatively or additionally) execute the instructions.

As a person skilled in the art will recognize from the previous detailed description and from the drawing FIGS. and claims set forth below, modifications and changes may be made to the embodiments of the present application without departing from the scope of this present application as defined in the following claims.

Although the foregoing examples have been described in some detail for purposes of clarity of understanding, the above-described inventive techniques are not limited to the details provided. There are many alternative ways of implementing the above-described techniques or the present application. The disclosed examples are illustrative and not restrictive.

What is claimed is:

1. A system of wearable wireless devices, comprising:
a leader device including a processor electrically coupled with a sensor system, a power system, data storage, and a communications interface including a radio,
the leader device configured to be worn by a user, to sense motion of the user using a multi-axis sensor in the sensor system, to generate motion signals from the motion, to process the motion signals in the processor, and to transmit to a wirelessly linked device the processed motion signals using the radio;
a follower device including a processor electrically coupled with a haptic interface, a power system, data storage, and a communications interface including a radio,
the follower device comprises the wirelessly linked device and is configured to receive the processed motion signals using its radio, to process in its processor the received motion signals, to generate using the haptic interface, haptic prompts synchronized to the motion signals, the follower device configured to be worn by another user and to mechanically couple the haptic prompts to a body of the another user.

2. The system of claim 1, wherein the leader device includes a haptic interface electrically coupled with its processor.

3. The system of claim 1, wherein the follower device includes a sensor system electrically coupled with its processor.

4. The system of claim 1, wherein wirelessly linked comprises establishing a wireless link between the radio of the leader device and the radio of the follower device using Near Field Communication (NFC).

5. The system of claim 1, wherein wirelessly linked comprises establishing a wireless link between the radio of the leader device and the radio of the follower device using Bluetooth (BT) paring.

6. The system of claim 1, wherein wirelessly linked comprises establishing a wireless link between the radio of the leader device and the radio of the follower device using any 802.11 protocol.

7. The system of claim 1 and further comprising:
a plurality of the follower devices wirelessly linked to the leader device and receiving the processed motion signals using their respective radios.

8. The system of claim 1 and further comprising:
a plurality of the leader devices; and
a plurality of the follower devices where a number of follower devices in the plurality of the follower devices is greater than or equal to a number of leader devices in the plurality of the leader devices,
wherein the radio in each leader device wirelessly links with the radios in a subset of the plurality of the follower devices using a haptic channel that is different for each leader device.

9. The system of claim 1, wherein the leader device includes a haptic interface electrically coupled with its processor and the follower device includes a sensor system electrically coupled with its processor and the leader and follower devices are configured to be reversibly switchable between being leader or follower devices.

10. A system of wireless devices, comprising:
a wireless media device including a processor electrically coupled with a power system, data storage, an audio system including a speaker, and a communications interface including a radio,
the wireless media device configured to transmit motion signals to a wirelessly linked device using the radio;
a wearable wireless device including a processor electrically coupled with a haptic interface, a power system, data storage, and a communications interface including a radio,
the wearable wireless device comprises the wirelessly linked device and is configured to receive the motion signals using its radio, to process in its processor the received motion signals, to generate using the haptic interface, haptic prompts synchronized to the motion signals, the wearable wireless device configured to be worn by a user and to mechanically couple the haptic prompts to a body of the user.

11. The system of claim 10, wherein the wearable wireless device includes a sensor system electrically coupled with its processor.

12. The system of claim 10, wherein wirelessly linked comprises establishing a wireless link between the radio of the wireless media device and the radio of the wearable wireless device using Near Field Communication (NFC).

13. The system of claim 10, wherein wirelessly linked comprises establishing a wireless link between the radio of the wireless media device and the radio of the wearable wireless device using Bluetooth (BT) paring.

14. The system of claim 10, wherein wirelessly linked comprises establishing a wireless link between the radio of the wireless media device and the radio of the wearable wireless device using any 802.11 protocol.

15. The system of claim 10, wherein the motion signals comprise content in a non-transitory computer readable medium disposed in the data storage of the wireless media device.

16. The system of claim 10, wherein the motion signals comprise content wirelessly received by the radio of the wireless media device.

17. The system of claim 10, wherein the wearable wireless device includes a sensor system electrically coupled with its processor and the wearable wireless device is configured to be reversibly switchable between being a leader device or a follower device.

18. The system of claim 10 and further comprising:
a plurality of the wearable wireless devices; and
a plurality of wireless links between the plurality of the wearable wireless devices and the wireless media device, each wireless link comprises a haptic channel that is different for each wireless link and is assigned to a specific subset of the plurality of the wearable wireless devices.

19. The system of claim 18, wherein each haptic channel includes motion signals that are different than motion signals in other haptic channels.

20. A method for a wearable wireless device, comprising:
activating a plurality of wearable wireless devices;
linking the plurality of wearable wireless devices, the linking operative to place each wearable wireless device in wireless communication with other of the plurality of wearable wireless devices;
assigning haptic channels to the plurality of wearable wireless devices;
generating motion signals from a first subset of the plurality of wearable wireless devices;
wirelessly transmitting the motion signals from the first subset to a second subset of the plurality of wearable wireless devices;
receiving the wirelessly transmitted motion signals at the second subset;
processing the motion signals received in each of the plurality of wearable wireless devices in the second subset; and
generating haptic prompts in each of the plurality of wearable wireless devices in the second subset based on the processing.
